(19) United States
(12) Patent Application Publication
(10) Pub. No.: US 2019/0333119 A1
(43) Pub. Date: Oct. 31, 2019

(54) System and Method for Evaluating and Reserving Rooms

(71) Applicant: Timothy W. SWENY, Fairview, PA (US)

(72) Inventor: Timothy W. SWENY, Fairview, PA (US)

(21) Appl. No.: 16/396,097

(22) Filed: Apr. 26, 2019

Related U.S. Application Data
(60) Provisional application No. 62/663,849, filed on Apr. 27, 2018.

(51) Int. Cl. G06Q 30/02; G06Q 50/12; G06Q 10/02; G06Q 30/06

(52) U.S. Cl. CPC G06Q 30/0282; G06Q 30/0627; G06Q 10/02; G06Q 50/12

(57) ABSTRACT

A method and system for rating and identifying hotel rooms is provided. Mobile devices including sensors therein are advantageously utilized to make objective measurements of room criteria. Individual rooms are rated and matched to user preference profiles.

### RELATED APPLICATION

This application claims priority to U.S. Provisional Application No. 62/663,849, filed on Apr. 27, 2018, the entire disclosure of which is incorporated herein by reference.

### FIELD OF THE INVENTION

The present invention relates to applications for evaluating and reserving rooms such as hotel rooms. More particularly, the present invention relates to an application running on a computer or mobile phone that utilizes sensors and/or user supplied input, among other things, to subjectively and objectively evaluate various aspects of hotel rooms, and permits users to search for and reserve specific rooms within a hotel based on collected evaluation data and user preferences.

### BACKGROUND OF THE INVENTION

There are many existing ways of finding a hotel room. There are existing mobile apps that permit a user to locate a room based on certain criteria. However, all current solutions fail to objectively measure a wide range of criteria of hotel rooms, and provide customized profiles for users, so that each user can locate a specific room or set of rooms within a hotel in real time based on a set of criteria that each user determines is important to them. Current booking solutions and hotel chain websites do not provide information specific to unique rooms within a hotel.

### BRIEF DESCRIPTION OF THE DRAWINGS

The invention will be more readily understood with reference to the embodiments thereof illustrated in the attached drawing figures, in which:

FIG. 1 is a flow chart illustrating the functions of an app according to an exemplary embodiment of the invention;

FIGS. 2-6 are exemplary user interface screenshots of an app running on a mobile device according to an exemplary embodiment of the invention;

FIG. 7 is a flow chart illustrating data inputs, transformations and outputs that occur within a system according to an exemplary embodiment of the invention;

FIGS. 8A and 8B are a table illustrating exemplary data collected and analyzed according to an exemplary embodiment of the invention;

FIG. 9 is a logical architecture diagram of an exemplary embodiment of the invention;

FIG. 10 is a logical architecture diagram illustrating a new user account creation request according to an exemplary embodiment of the invention;

FIG. 11 is a communication flow diagram for account creation according to an exemplary embodiment of the invention;

FIG. 12 is a communication flow diagram for user login validation according to an exemplary embodiment of the invention;

FIG. 13 is a communication flow diagram for a user searching and booking a room according to an exemplary embodiment of the invention;

FIG. 14 is a communication flow diagram for user feedback according to an exemplary embodiment of the invention;

FIG. 15 is a system architecture diagram according to an exemplary embodiment of the invention;

FIG. 16 illustrates application components according to an exemplary embodiment of the invention;

FIG. 17 illustrates exemplary data collected by exemplary embodiments of the invention;

FIG. 18 is a user interface screen for leaving feedback according to an exemplary embodiment of the invention;

FIG. 19 illustrates a series of user interface screens provided according to an exemplary embodiment of the invention;

FIG. 20 is a user interface home screen according to an exemplary embodiment of the invention;

FIG. 21 further illustrates the home screen presenting a list of hotels according to an exemplary embodiment of the invention;

FIG. 22 is a user interface trip screen according to an exemplary embodiment of the invention;

FIG. 23 is a user interface feedback screen according to an exemplary embodiment of the invention;

FIG. 24 is a further user interface feedback screen according to an exemplary embodiment of the invention;

FIG. 25 is a further user interface feedback screen according to an exemplary embodiment of the invention;

FIG. 26 is a further user interface feedback screen according to an exemplary embodiment of the invention;

FIG. 27 is a further user interface feedback screen according to an exemplary embodiment of the invention;

FIG. 28 is a user interface leaderboard and wallet screen according to an exemplary embodiment of the invention;

FIG. 29 is a user interface profile screen according to an exemplary embodiment of the invention;

FIG. 30 is a menu bar portion of an application user interface according to an exemplary embodiment of the invention;

FIG. 31 illustrates a reservation workflow according to an exemplary embodiment of the invention;

FIG. 32 illustrates another reservation workflow according to an exemplary embodiment of the invention;

FIG. 33 illustrates a reservation workflow where the user does not have a reservation according to an exemplary embodiment of the invention;

FIG. 34 is a user interface screen of a map view according to an exemplary embodiment of the invention;

FIG. 35 is a user interface feedback screen according to an exemplary embodiment of the invention;

FIG. 36 illustrates a day of reservation workflow according to an exemplary embodiment of the invention;

FIG. 37 illustrates a profile creation workflow according to an exemplary embodiment of the invention; and

FIG. 38 illustrates various user roles according to an exemplary embodiment of the invention.

Throughout the drawings, like reference numbers should be understood to refer to like elements, features and structures.

### DETAILED DESCRIPTION OF THE EXEMPLARY EMBODIMENTS

The exemplary embodiments of the invention will now be described with reference to the attached drawing figures. A purpose of an exemplary embodiment of the invention is to provide a consumer with the best available room at a hotel, in real time, that matches what they want most in a hotel room. An app according to an embodiment preferably provides users with different profiles, such as for business and leisure, which can have different criteria and priorities. The criteria and recommendations of the app can change day to day depending on how the app community or others report on a particular hotel room.

Hotels benefit from the app by receiving information and feedback from users to improve their guest rooms, and potentially to charge a premium for higher rated rooms.

Users can advantageously use the app when traveling, such as by car, and provide the user with on-the-fly room availability based on room ratings and criteria, where they are located at the time, the planned destination, stop time, among other factors.

The app is advantageously integrated with navigation devices and other apps to notify the user of available rooms on the fly and specifically those best matching the user's profile and their list price. Unlike conventional hotel room locators, embodiments of the invention notify the user of exact room numbers available and/or room numbers to avoid. For example, if booking a room, the app knows the area being searched, the city, state, and so on, and advises the user how many “Gold” rooms are available in each of the hotels in a given area. “Gold” is a term used to mean a room meeting a certain threshold of user profile criteria. The user can then see how many Gold, Silver, etc. rooms each hotel has available in total, and how many are available at the moment. The user may thus be able to learn that one hotel has double the number of gold rooms total, compared with another hotel, and therefore the first hotel is more likely to have one available at check in.

The app can also take the form is bolt-on data panels in third party web sites or mobile apps, or the like, when searching for hotels rooms using existing on-line hotel room location sites. These panels also provide the user with the number of total and available rooms by profile criteria at each hotel.

An aspect of an exemplary embodiment of the invention is to use community input and real time communication and reporting. So that the app or other interface to the system data is updated in real time, and based on community input and feedback.

Advantageously, objective data for specific room is measured by users utilizing, among other things, the various sensors and input devices available on mobile devices. Accordingly, the app's profile matches and recommendations can be based on objective measurements. For example, the microphone of a mobile device can measure ambient noise level, or noise from the elevator, or periodic noise in the hallway. Motion sensors are used to test things like room layout, distance from bed to bathroom, even mattress softness.

The app preferably rates each room based on how well the room's measured criteria match the user's preference profile. Users can drill down to specific important features of the room to learn more. The app also preferably aggregates all rooms in the hotel for a total hotel rating based on the user's preference profile.

The app also preferably provides users with any pertinent updates on a room, such as for example to pre-booking a particular room when it becomes available, or making a room request. In one aspect of embodiments of the invention users identify broken items in a room, which can be reported to the hotel management. Broken items are then able to be fixed more efficiently. Data stored and analyzed by the system includes whether a room was updated or remodeled, recent events in the room, and goings on around the room that may be pertinent to the user. For example, a user might be interested to know that a sports team just checked in to rooms nearby.

While searching for rooms online, the system preferably provides users with the total number of rooms and number of rooms available (not booked) that meet the user's preference profile to the level of gold, silver, and so on. Optionally, the system also identifies the number of rooms below a certain rating level, or with particular problems or undesirable criteria. The system preferably facilitates the drill down to actual room numbers and data available for each individual room.

At check in, the system allows users to see the available rooms and their ratings (weighted to the user's preference profile), and provides a listing of rooms ranked best to worst relative to the user's preference profile.

The backend database of the system described herein may be incorporated into online mapping tools, or other navigation sites, providing hotel room availability data on the fly as the user travels, along with the number of rooms and number available per rating level per hotel, and within a certain distance from the user's current location, their planned destination, or along their route.

The system preferably includes links with social media to show other users of the system, or other friends, and allows interaction in a game-like manner to encourage adoption and use of the app.

Using the system, community hotel ratings can advantageously be verified based on objectively measured data, rather than mere opinions like conventional star ratings.

The system and app based on the system preferably provide users with a graphic representation of a room's location relative to the complex, as well as the individual room layout.

The system preferably provides users with a room report daily or at the end of their stay. The system correlates actual measured readings to the user's preference profile and an actual rating level during their stay to the level provided at check in. The system preferably makes requests from random users for feedback that permits ongoing accuracy improvement.

The availability of particular rooms may be determined by process of elimination. Hotels will provide information to the app database as guests are checked in and out so that the app database has an ongoing record of which rooms are open. Hotels feed a list of room numbers taken and the number of rooms booked for the night. The system then determines that a given set of rooms are available, and a certain number of them have been booked. Accordingly, the system calculates that any of the remaining rooms may be booked according to the number of bookings before the user physically arrives at the hotel.

In addition, the system uses community input and feedback to reports on who is at what hotel and in what room. That is, users of the system can self-report which room they checked into. Accuracy of data is preferably limited to the percentage of guests using the app.

A mobile device running the app can also determine which rooms are available via the app technology. For example, RFID may be used together with a sensor in the room. If there has been no activity recorded in a certain amount of time, the app could be programmed to assume that the room is available. In another embodiment, GPS and a digital map of the hotel complex could provide necessary information for the system to determine available rooms. Precise GPS measurements that include altitude measurement by mobile devices of system users can identify occupied rooms within a hotel. The system also takes into account the combination of various GPS measurements. For example, activity in a certain location between certain hours indicate a booking for the evening. Activity after check-in time would indicate a booking but lack of activity under the circumstances may not necessarily mean an open room. Social media data that tracks user location is optionally combined with and utilized by the system to define activity in or around specific GPS coordinates.

Embodiments of the system, including instances of the app running on multiple users' mobile device advantageously learn and improve over time by receiving room location data from the app community, together with user answers to questions posed by the app. For example, if the app knows a user's mobile device is in a particular room based on knowledge of check-in, or confirmation by the user, the app can take a GPS reading. By correlating enough room numbers to the readings it takes, the system can devise an accurate map of the hotel. The app can optionally pose questions to users such as “Are your checking in at the lobby now?” or “Help us improve your app by checking in when you visit the restaurant”. The act of checking in at various locations on the premise allows the system to build its own CAD layout of a hotel facility. Preferably, the mobile app includes an easily accessible button for the user to indicate they are checking in to a location, and once the button is activated, a list of possible locations is presented for the user to choose from. The list could include, for example, restaurant, pool, exercise room, lobby, game room, ice-vending, my room, bar, and so on. Identifying one of these locations with the button interface tags an important location in the building to a GPS coordinate. As will be appreciated, additional crowd data improves the map. Preferably, a game incorporates the mapping function to encourage use by users.

In one aspect of the game aspect of the mobile app, an amount of money is pooled, and small monetary prizes are randomly given to users who provide useful data. Options include making the payout larger at times or, depending on the available pool of money and the number of players, among other options. Players could pay into the app as part of an annual subscription, for example, from which the money pool is collected.

Phone Sound Meter

Embodiments of the invention preferably use the microphone of a mobile device to measure ambient sound in and around hotel rooms. One such measurement is the amount of noise in the room itself, from appliances, the air conditioning, etc. The other is noise generated from outside the room. Things that cannot be changed like proximity to a noisy street or being on the side of the building closest to the airport or train tracks. These factors will generate noise consistently at certain times of the day, or days of the week. Other outside noise may be generated from other guests and this condition might change day to day. Advantageously, time-tagging noise measurements will identify consistently noisy rooms, as opposed to high noise levels for a transient reason. For example a user might check-in to a hotel for a one night business stay. A traveling high school basketball team checked in last night and is staying for a couple more days. The app community will most likely identify high outside noise levels for those rooms nearest the team rooms. A combination of collected data and app questions is advantageously able to identify the reason for the noise level and the expected longevity of the condition.

While simple surveys of users may provide enough information to determine ongoing and transient noise levels in hotel rooms, preferably the app takes measurements with no or minimal user intervention. This avoids “opinion” data given by users and provides objective measurable and repeatable data to the system.

Fitness trackers, and other devices that provide sleep data, preferably are incorporated into the system to measure sleep quality, which may be attributable to a number of factors including mattress or bed quality.

The mobile device camera can be used to capture photos and 360 degree views of individual rooms that users can view when deciding on a hotel room to reserve.

Motion detectors within a mobile device are advantageously used to collect context relevant data. For example, a mobile device can detect if you have been sitting, or sitting and rolling around like some users do in a desk chair. The app can determine based on the motion data that the user has been sitting at a desk chair, and then ask the user questions about the desk chair.

The app and system preferably provide a feedback mechanism so that the system improves over time. For example, the system may rate a room highly based on the user's preference profile, but the user then rates the room poorly. The app and system can poll the user, and measured data, to determine the sources of deviation from user preference to measured room data, and thereby improve ongoing preference matching.

As discussed herein, various sensors found in mobile devices are used to make objective measurements within and around hotels. For example, bed firmness, sound levels in a room, water pressure, the time required for check-in, and Wi-Fi signal strength can all be measured by most existing mobile devices. Mobile device data transmission capabilities are used to auto record conditions into a database of the system. Location determination sensors are used to create 3D hotel maps. Subjective data can also be combined into the database, so that user feedback can aggregate information on staff friendliness. The distance to the hotel from an interstate exit, and to a restaurant, are incorporated into the database of factors.

The accumulated data stored in the system database maybe utilized in a number of advantageous ways. Primarily, hotels can use the data to their advantage to improve their rooms and service. Local merchants may also be interested in the data to provide goods or services to the hotel or their guests.

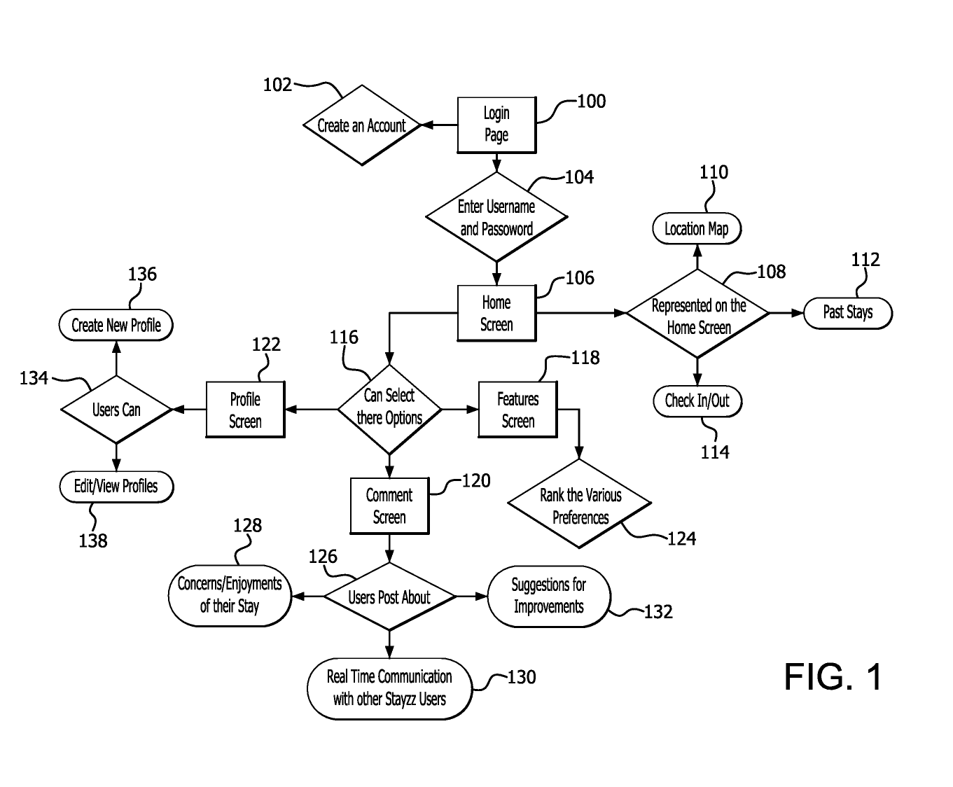

Turning to the figures, FIG. 1 is a flow chart illustrating the various states of an application according to an exemplary embodiment of the invention. The application preferably starts out displaying a login page 100 and from the login page a user can either create a new account 102 or they can enter their user password if they already have an account at 104. If they have an account and they login, the application displays a home screen 106. From the home screen, several things are represented as shown at 108. First, a location map 110 is shown. Secondly, an option to check past stays 112 is displayed and also an option to check in or out of a hotel is displayed at 114. In addition, from the home screen 106, the user can select a series of options as shown at 116. The user can select a feature screen 118 or a comment screen 120 or profile screen 122. If the user selects the feature screen, they are taken to 124 where they mark their various preferences for hotel rooms, as will be described later in greater detail. If they go to the comment screen 120, users are given the option to post about various aspects of their hotel stays at 126. These include concerns or enjoyments of their stay at 128, the option for real-time communication with other users of the app at 130, or to provide suggestions for improvements to the hotel or to the app at 132. If, at profile screen 122, the user is given several options as illustrated at 134, first the user can create a new profile 136 and secondly the user can edit or view existing profiles at 138.

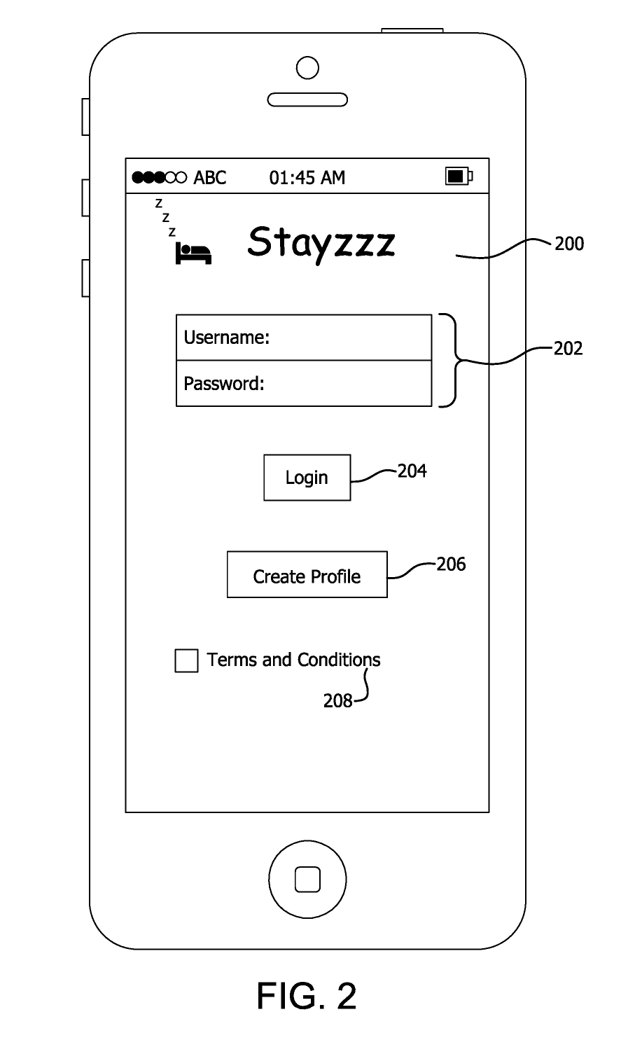

FIG. 2 is a login screen of an exemplary app running on a mobile device. The login screen 200 provides a user name and password section 202, a login button 204 and a user control to create a new profile 206. Preferably, the user terms and conditions are provided on the login screen. User terms and conditions 208 can preferably include an option to indicate that the terms and conditions have been accepted.

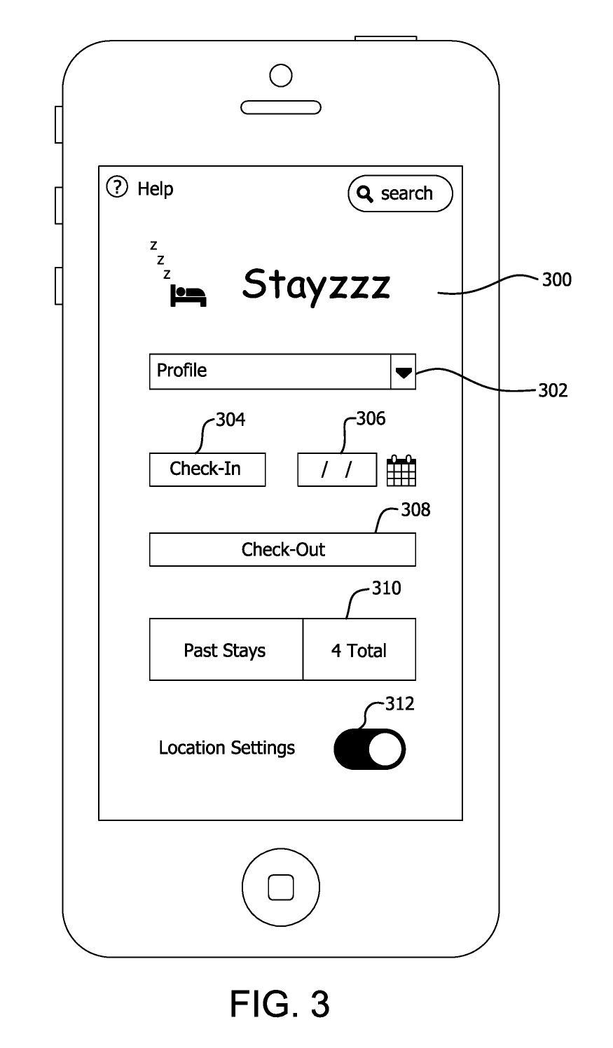

FIG. 3 is an exemplary user interface showing user profile. User interface screen 300 illustrates the profile user interface. Among the various user interface screens, a drop down box 302 is provided and as shown in user interface screen 300, the profile user interface has been selected. A check in button 304 and date 306 are provided and a check out 308 button is provided. A total of past stays is presented at 310 and location settings can be toggled on or off at 312.

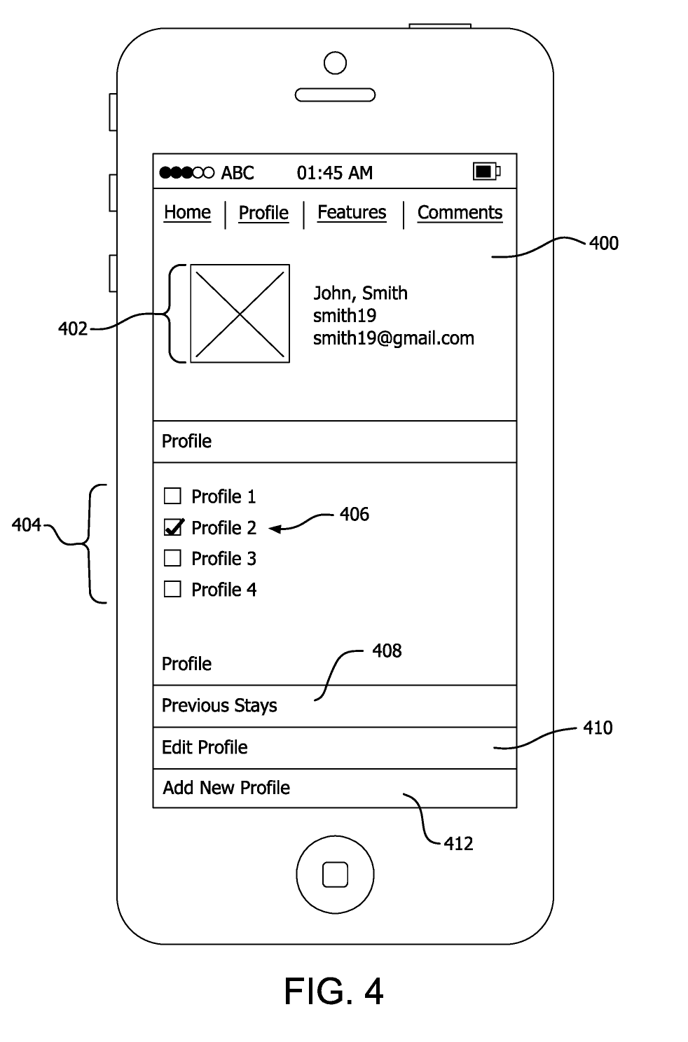

FIG. 4 illustrates a profile selection interface according to an exemplary embodiment of the invention. User interface screen 400 is illustrated at FIG. 4. Here the currently selected profile 402 is displayed at the top of the screen. A set of existing profiles 404 is also provided along with an indication of the selected profile 406. Options to view previous stays for the currently selected profile 408 is provided, a control to edit current profile 410 is provided, and a control to add new profile 412 is provided.

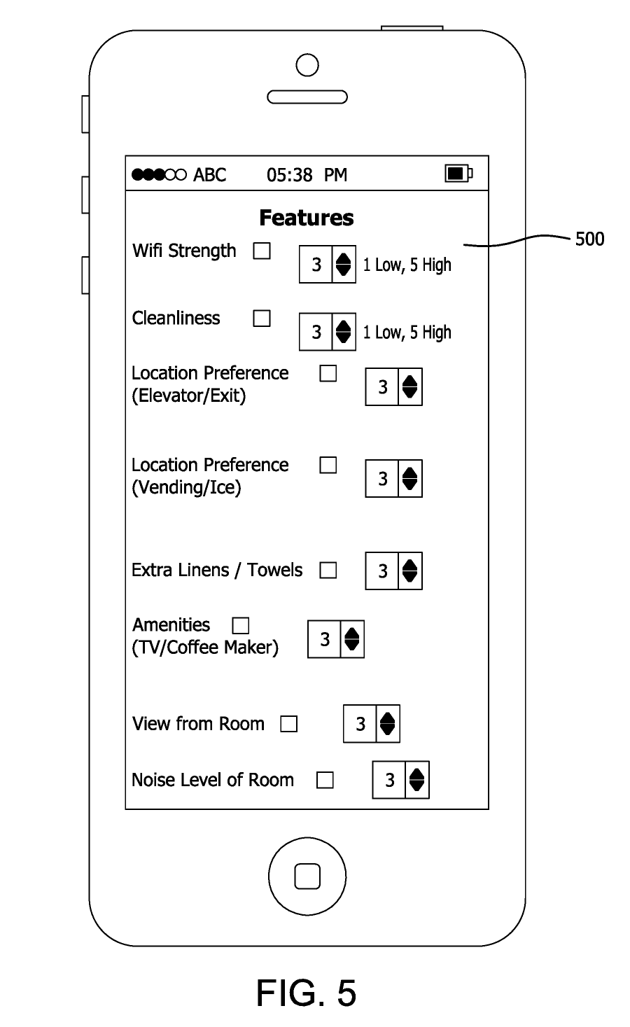

FIG. 5 illustrates an exemplary interface for rating and viewing ratings of various criteria for a particular hotel room. User interface screen 500 illustrates various exemplary ratings of hotel room characteristics is displayed as illustrated and as is merely exemplary, the features that are able to be rated include Wi-Fi strength, cleanliness, location preference with regard to elevators and exits, location preference with regard to vending machines and ice, extra linens and towels, amenities such as TV or coffee maker, the view from the room, and the noise level in the room. All of these features can be ranked, for example from low to high, and check boxes are provided so that the user can indicate which features they wish to be utilized in ranking the importance of features for that particular user profile.

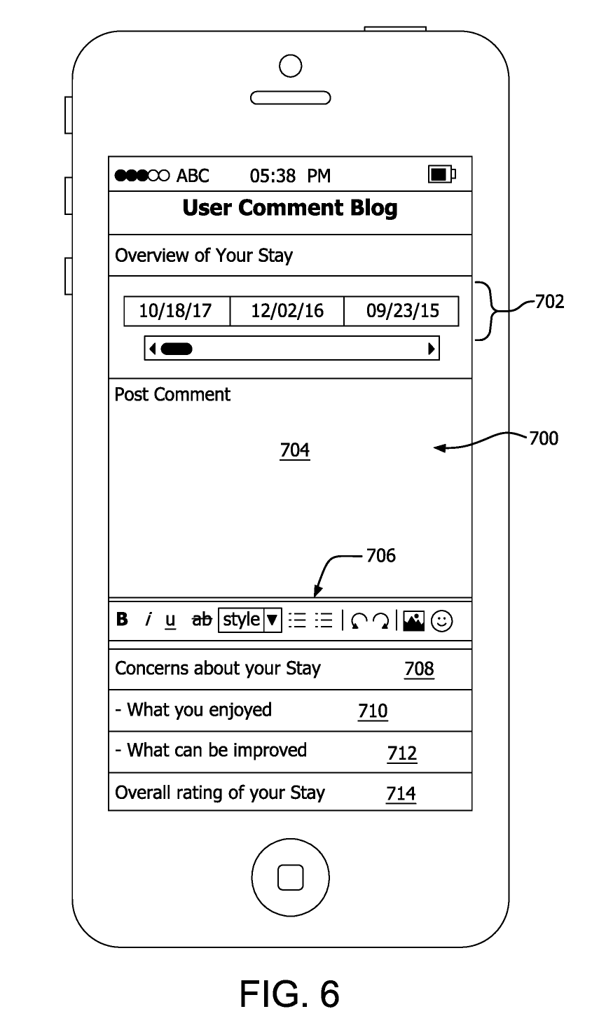

FIG. 6 illustrates an exemplary user interface for providing comments on an overall stay. A user interface exemplary screen 700 is provided for users to enter comments. A user is able to select dates of a particular stay that they want to comment on at 702. They are able to enter text of a comment at 704. Font and style controls are provided at 706. A control to enter concerns about the user's stay is provided at 708. A user can enter what they enjoyed at 710, what can be improved at 712 and the user can provide an overall rating for their stay at 714.

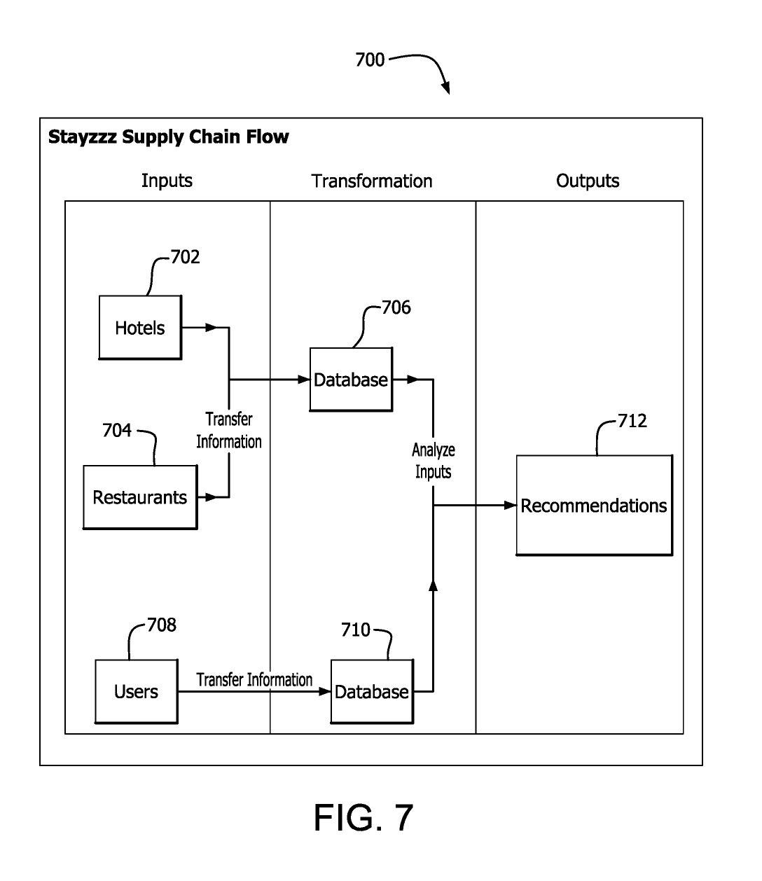

FIG. 7 illustrates data flow within an exemplary system 700. As shown hotels 702 and restaurants 704 feed data into a first database 706. Users 708 feed data into a database 710 that may be separate or the same as the hotel/restaurant database 706. Data from both databases 706/710 is analyzed and compared to user preference profiles, and recommendations 712 of hotels, preferably including particular individual rooms within hotels are provided to the user based on how well individual rooms match the user's preference profile.

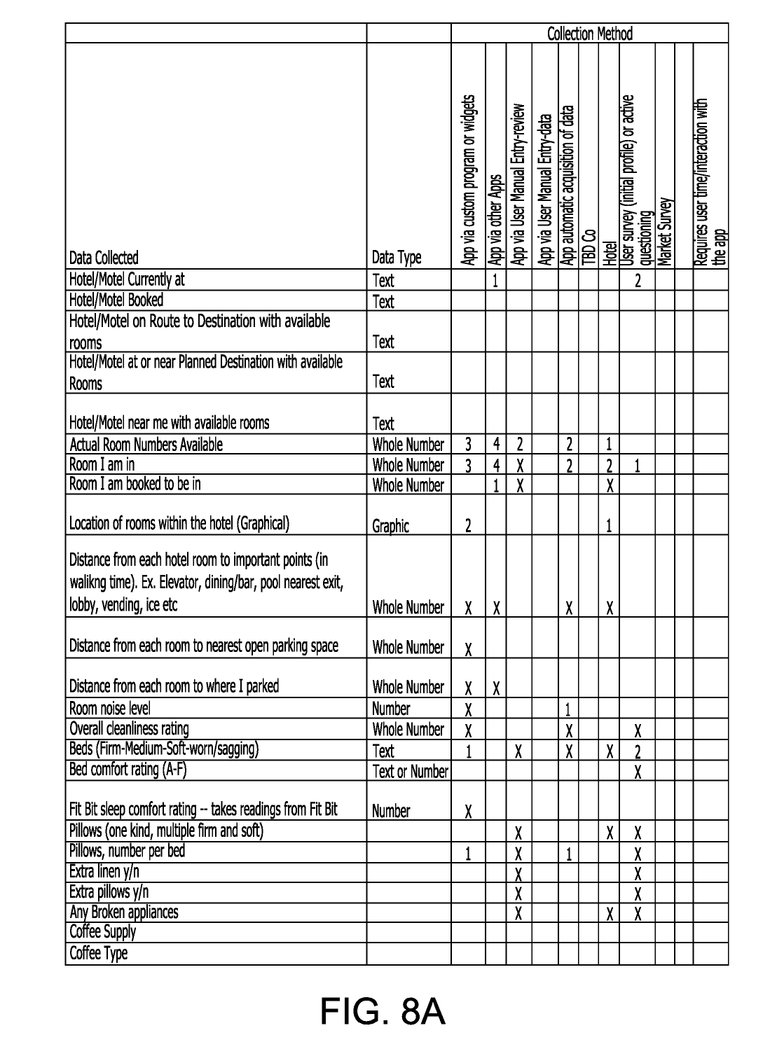

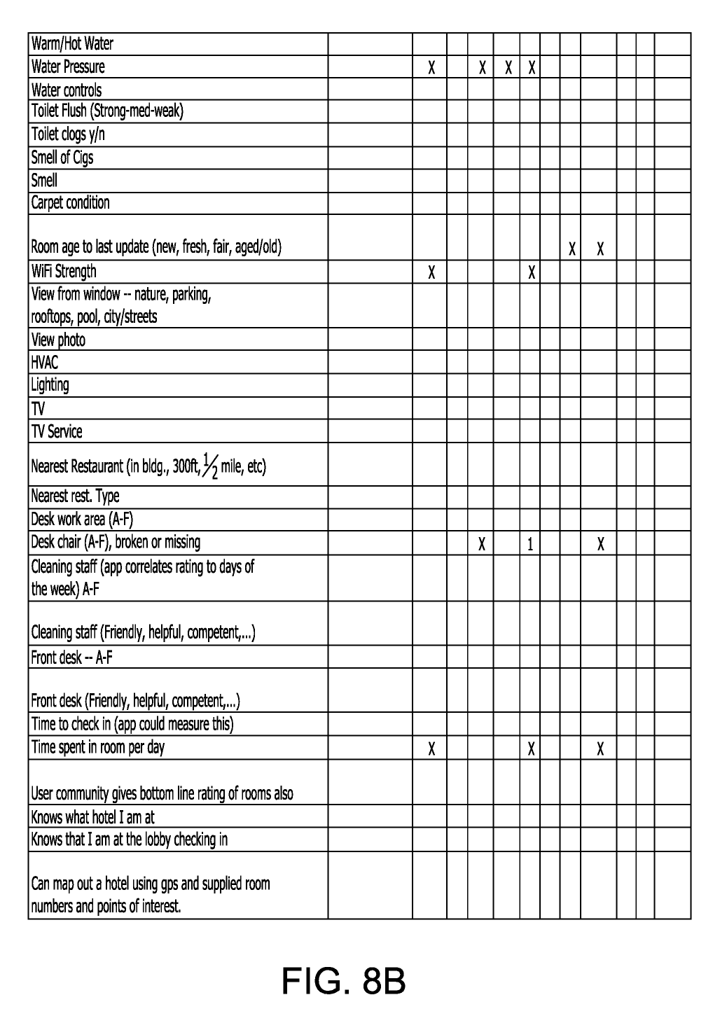

FIGS. 8A and 8B illustrate an exemplary listing of various data and data types that are collected by an exemplary system, as well as the data collection method.

The following are merely exemplary of the kinds of data and measurements relative to hotel rooms that the system and measure, track, and/or analyze:
Wi-Fi strength
Smell
Cleanliness
   Carpet
   Linens
   Bathroom
Floor Location
Noise
Proximity to:
   Elevator
   parking
   Lobby, Breakfast
Pillow quantity
Pillow firmness
Bed Firmness or comfort
View
TV Size
   picture quality
   channels
coffee type
Refrigerator in room
microwave in room
temperature of water for shower
water pressure for shower
toilet flush or clogs
Soap
Towels
Extra linens, blankets, pillows
Updated
desk, working area
desk chair
Lighting
Room layout
   Bath and toilet separated or together
   closet space
Room alerts such as thing wrong or broken in the room

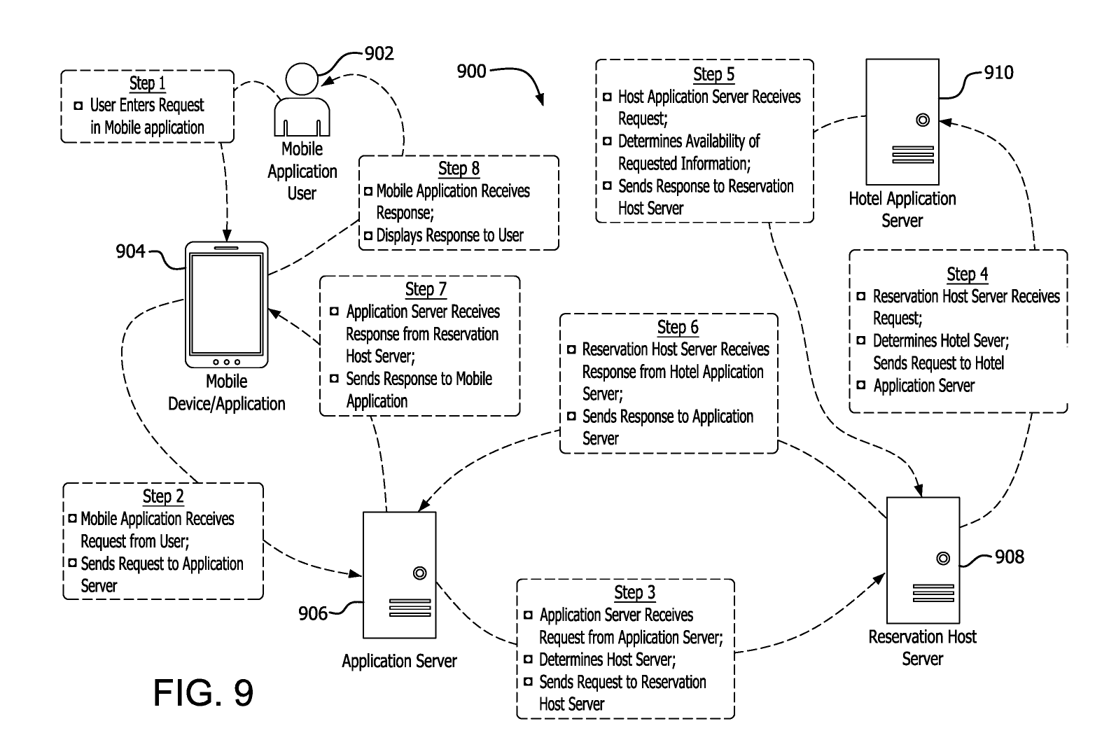

FIG. 9 provides an exemplary logical architecture for a system according an exemplary system 900 according to an exemplary embodiment of the invention. The system includes a mobile application user 902, a mobile device or application 904, which is typically a portable device such as a mobile phone. The system further includes an application server 906, a reservation host server 908, and a hotel application server 910. A typical logical flow will now be described with regard to the various elements of FIG. 9. At step one, the user enters a request into their mobile application. At step 2, the mobile application receives the user request and sends a request to the application server. At step 3, the application server receives a request from the application server, determines the host server and sends a request to the reservation host server 908. At step 4, the reservation host server receives a request, determines the hotel server and sends a request to the hotel application server 910. At step 5, the hotel application server receives the request, determines the availability of the requested information and sends a response to the reservation host server 908. At step 6, the reservation host server 908 receives a response from the hotel application server 910 and sends a response to the application server 906. At step 7, the application server receives a response from the reservation host server and sends a response to the mobile application 904. Finally, at step 8, the mobile application receives the response and displays the response to the user 902.

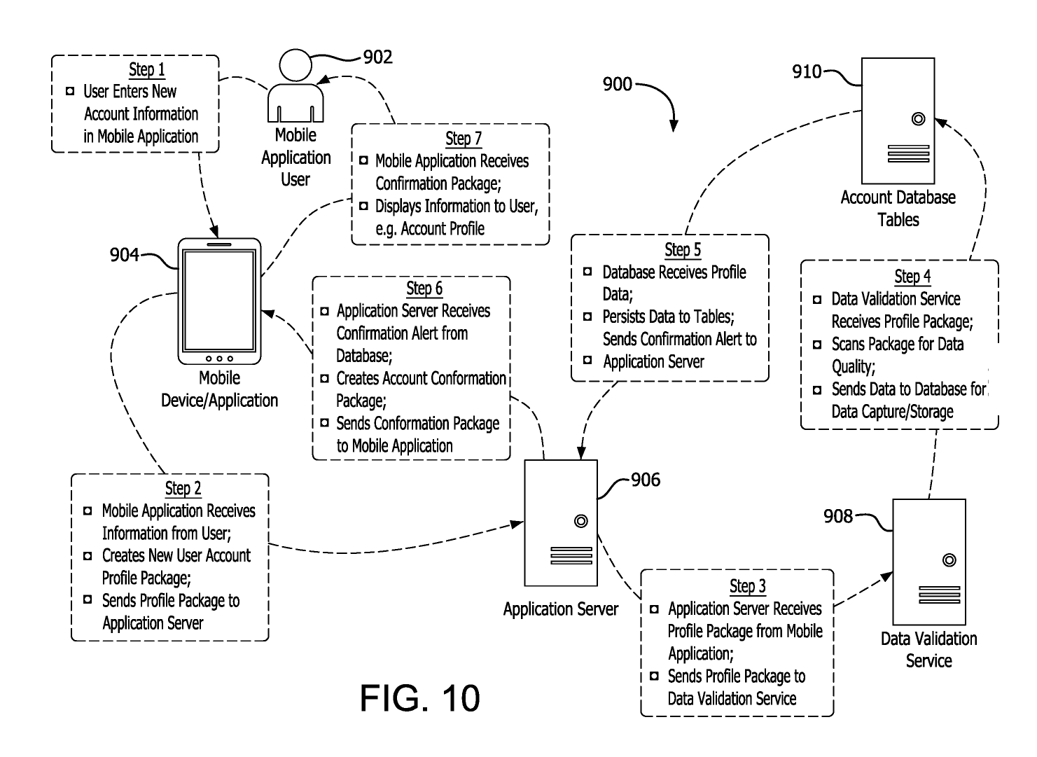

The previous description was for a basic request in a system according to an exemplary embodiment of the invention. Now a new user account creation request will be described in connection with FIG. 10. At step 1, user 902 enters new account information into the mobile their mobile application on the mobile device 904. In step 2, the mobile application device 904 receives information from the user 902, creates a new user account profile package and sends the profile package to the application server 906. At step 3, the application server receives the profile package from the mobile application and sends the profile package to a data validation service at data validation service server 908. At step 4, a data validation service receives the profile package, scans the package for data quality and sends data to the database for data capture and storage. At step 5, the database receives the profile data, persists the data to tables and sends a confirmation alert to the application server 906. At step 6, the application server 906 receives a confirmation alert from the database, creates an account confirmation package and sends the confirmation package to the mobile application 904. At step 7, mobile application 904 receives the confirmation package and displays information to the user such as the account profile.

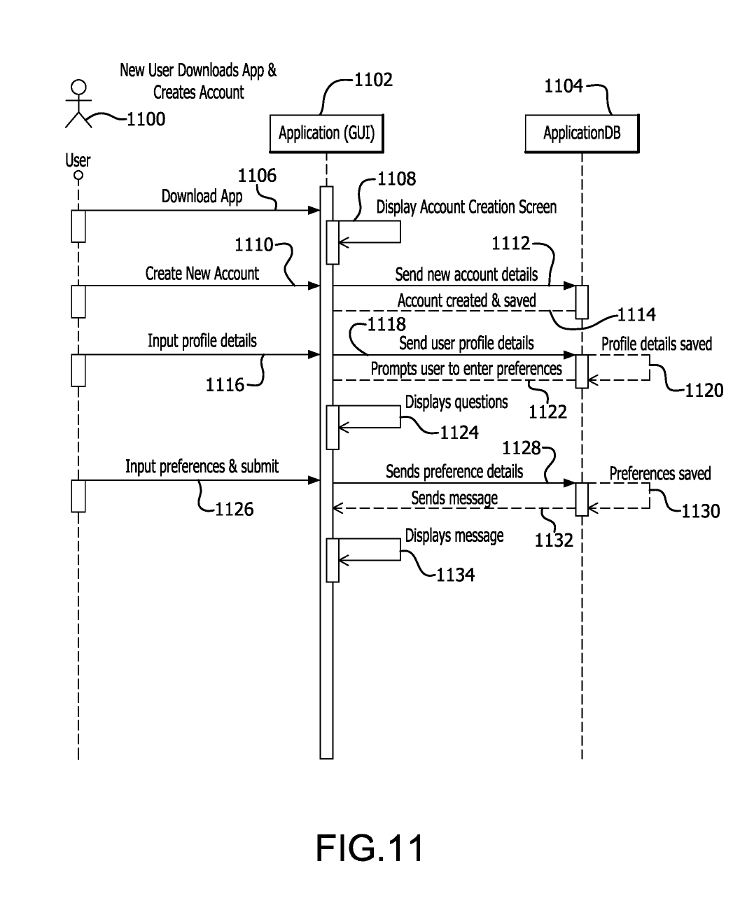

FIG. 11 illustrates exemplary communication flows between a user 1100, an application graphical user interface 1102, and a back end application database 1104. The first user downloads the app at step 1106. Next, the application displays the account creation screen at 1008. Next, the user requests that a new account be created at 1110. New account details are then sent from the application to the application database at 1112. Once the account is created and saved, an acknowledgement is returned from the database to the application at step 1114. At step 1116, the user inputs profile details into the application. The user profile details are then sent from the application to the application database at step 1118. Profile details are saved in the application database at step 1120 and an acknowledgement prompting the user to enter their preferences is returned from the database to the application at step 1122. Various questions are displayed to the user at step 1124 so that the user can enter their preferences. The user inputs their preferences and submits them to the application at step 1126. The preferences details are sent from the application to the application database at step 1128. The user preferences are saved in the application database at step 1130 and a message is returned from the application database to the application at step 1132, and a message confirming that the preferences were saved is displayed in the application graphical user at step 1134.

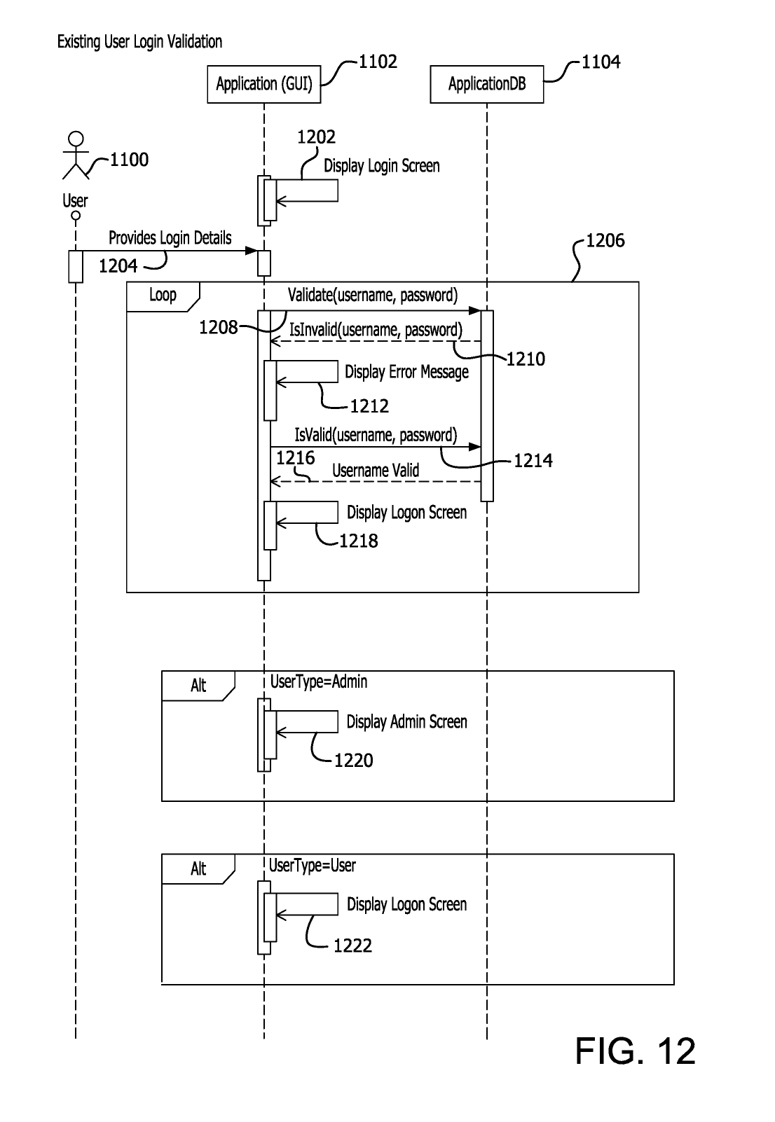

FIG. 12 illustrates an exemplary communication flow for a user login in accordance with an exemplary embodiment of the invention. At step 1202 the application GUI 1102 displays a login screen. At step 1204, a user provides login details which are entered into the GUI 1102. Next, a series of communications between the GUI 1102 and the application database 1104 occurs at 1206. These include a validation message including the username and password entered by the user transmitted from the GUI 1102 to the application database 1104 at step 1208. A message indicating whether the username and password were valid is transmitted from the application database 1104 to the application GUI 1102 at step 1210. If the username and were not valid, an error message is displayed at step 1212. If at step 1214 a request to determine if the username is valid is sent from the GUI 1102 to the application database 1104 at step 1214. The application database 1104 determines if the username is a valid username and returns a message indicating such to the GUI 1102 at step 1216. At step 1218, the log on screen is displayed at the GUI 1102. At step 1220, if the user type is determined to be an administrator, then the administrator screen is displayed in step 1220, and if the user is determined to be a normal user, then the user screen is displayed on the GUI 1102 at step 1222.

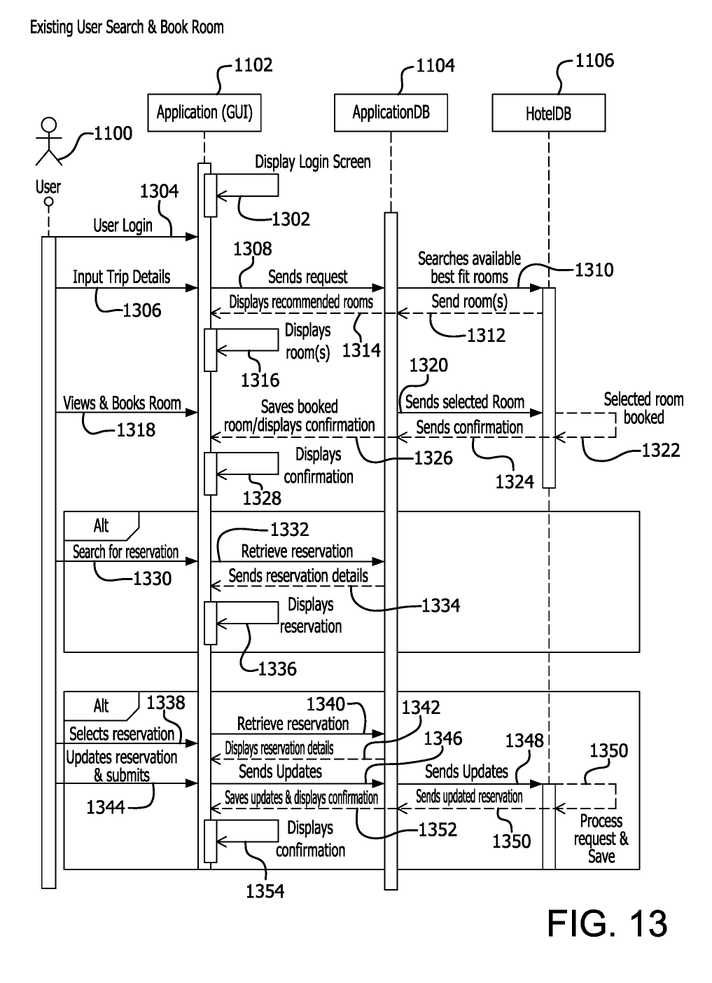

FIG. 13 illustrates an exemplary communication flow between a user 1100, a graphical user interface 1102, an application database 1104, and a hotel database 1106 in accordance with an exemplary embodiment of the invention. The login sequence previously described will be abbreviated for purposes of FIG. 13. At step 1302, the login screen is displayed on the GUI 1102. At step 1304, the user enters their login information into the graphical user interface 1102. At step 1306, the user 1100 inputs their trip details into the graphical user interface at step 1306. At step 1308, the graphical user interface 1102 sends the trip detail request to the application database 1104, and at step 1310, the application database sends a search request to the hotel database 1106 to search for available rooms with the best fit based on the trip details input by the user. At step 1312, the hotel database 1106 returns one or more available rooms that meet the criteria to the application database 1104. At step 1314, the recommended rooms are transmitted to the graphical user interface 1102 and displayed on the user interface. The available rooms are displayed on the graphical user interface at step 1316. At step 1318, the user views and books a selected room and enters their selection at step 1318 and the graphical user interface 1102. At step 1320, the selected room is transmitted from the application database 1104 to the hotel database 1106. At step 1322, the hotel database marks the selected room as being booked, and at step 1324, a booking confirmation message is sent from hotel database 1106 to the application database 1104. At step 1326, application database 1104 sends a confirmation message to the application GUI 1102 and the GUI 1102 displays the confirmation for the user at step 1328. The user can also search for an existing reservation by entering a search for reservation at step 1330. At step 1332, the GUI 1102 sends a request to retrieve the reservation to the application database 1104 as step 1334 reservation details are sent back to the GUI 1102. At step 1336, the reservation information is displayed on the GUI 1102. At step 1338, a user can select an existing reservation on the graphical user interface 1102. At step 1340, the GUI 1102 can send a message to retrieve that reservation from the application database 1104. Reservation details are returned from the application database 1104 to the GUI 1102 at step 1342. At step 1344, the user can update the reservation and submit the update in the GUI 1102. At step 1346, GUI 1102 sends the reservation updates to the application database 1104. At step 1348, the application database 1104 sends the updates to the reservation to the hotel database 1106. At step 1350, the reservation updates are processed and saved. In step 1352, hotel database returns the updated reservation information to the application database 1104. At step 1352, the updated reservation information is returned from the application database 1104 to the GUI 1102, and the updated confirmation information is displayed on the GUI 1102 at step 1354.

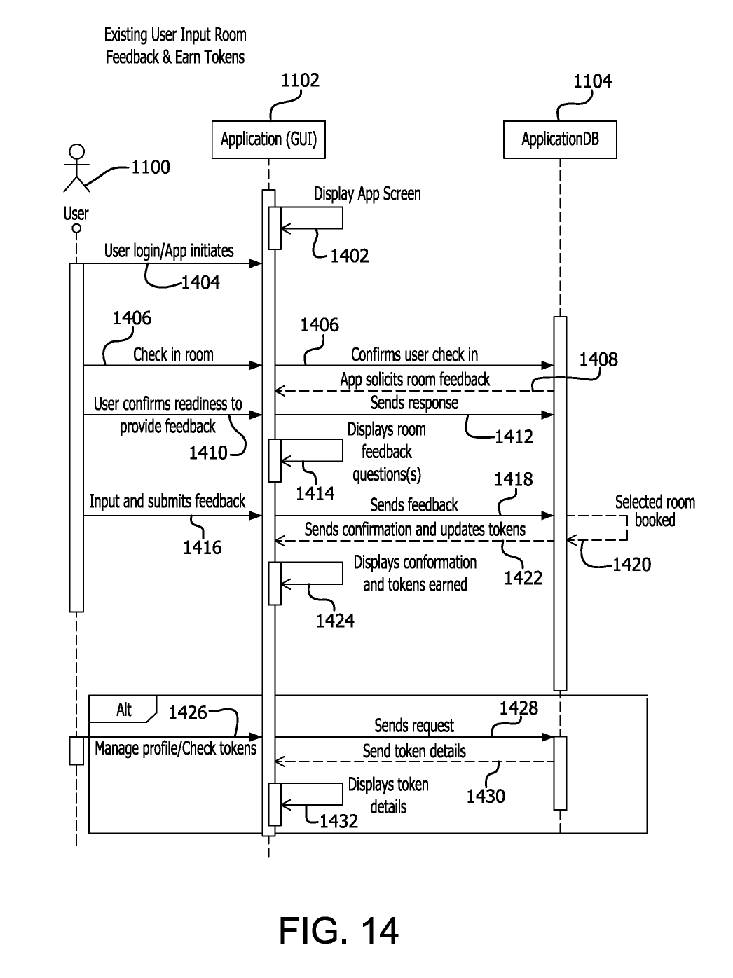

FIG. 14 illustrates a communication flow between the user 1100 and application GUI 1102 and an application database 1104 for user inputting room feedback and earning tokens according to an exemplary embodiment of the invention. At step 1404, the user 1100 logs into the GUI 1102. At step 1406, a user checks into the room via the GUI 1102. At step 1406, the GUI 1102 sends a check in confirmation message to the application database 1104, and at step 1408, the application database 1104 sends a solicitation message to request room feedback to the application graphical user interface 1102. At step 1410, the user indicates that they are ready to provide feedback regarding the room. At step 1412, the GUI 1102 sends a message to the application database 1104 indicating that a feedback response is ready. At step 1414, the GUI 1102 displays room feedback questions or input controls. At step 1416, the user enters their feedback information into the graphical user interface 1102. At step 1418, the room feedback is transmitted from the GUI 1102 to the application database 1104. At step 1420, the feedback information is saved or updated in the application database, and at step 1422, the application database updates a token or tokens based on the user's feedback and sends a confirmation of the same back to the GUI 1102. At step 1424, the confirmation of feedback and tokens earned are displayed on the GUI 1102. At step 1426, the user can manage their profile and as part of the same, can check on the status of an accumulation of tokens. At step 1428, the GUI 1102 sends a token status request to the application database 1104. At step 1430, the application database 1104 returns the users token details to the GUI 1102. At step 1432, the current token details for the user are displayed on the GUI 1102.

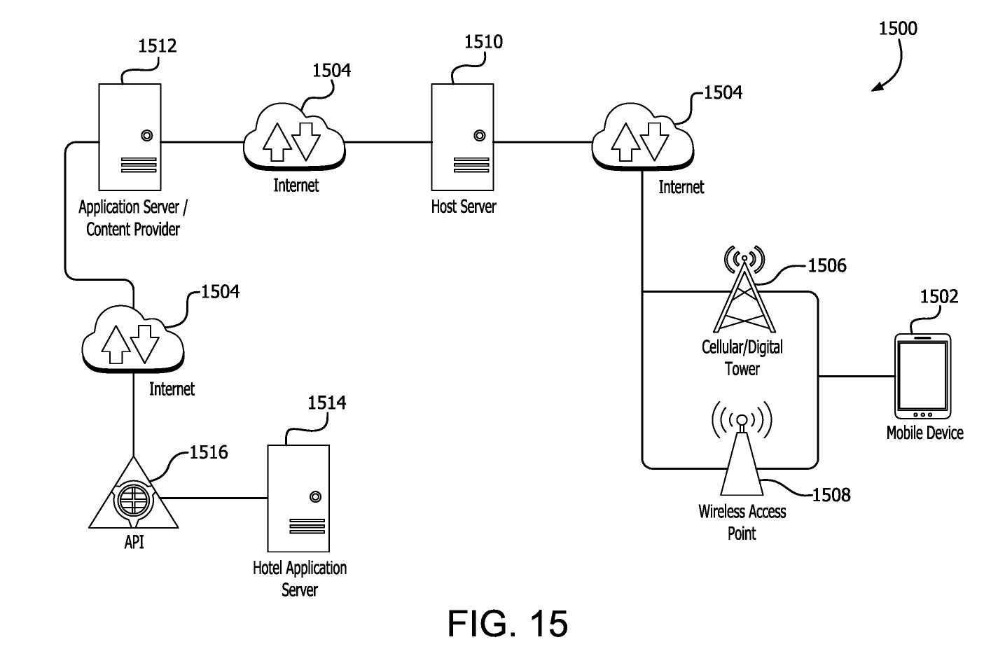

FIG. 15 illustrates a system architecture diagram for an exemplary system for a system according to an exemplary embodiment of the invention. A portable device such as a mobile phone 1502 is connected to the Internet 1504 via a cellular connection point 1506 such as a cellular base station or via conventional wireless Internet such as a wireless access point 1508. The host server 1510 is connected to the Internet. The application/content provider 1512 is connected to the Internet, and the host application server 1514 is connected to the Internet via an API 1516.

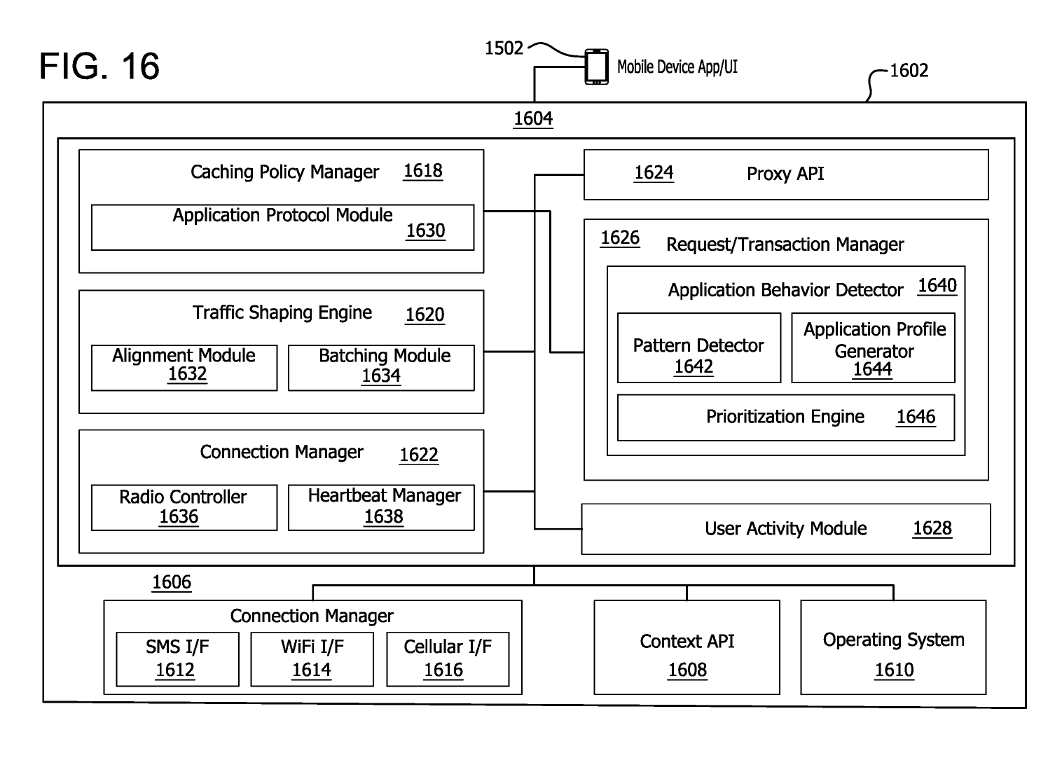

FIG. 16 illustrates various application components according to an exemplary embodiment of the invention. The mobile device 1502 includes an overall application user interface 1602. The application user interface 1602 includes various main components illustrated in the box 1604 together with the connection manager 1606, the context API 1608, and operating system 1610. The connection manager 1606 includes, preferably, an SMS 1612, Wi-Fi 1614 and cellular 1616 to provide a wide variety of communication means as will be appreciated by those of ordinary skill in the art. The main components 1604 include a caching policy manager 1618, a traffic shaping engine 1620, a connection manager 1622, a proxy API 1624, a request and transaction manager 1626, and a user activity module 1628. The caching policy manager 1618 includes an application protocol module 1630. The traffic shaping engine 1620 preferably includes an alignment module 1632 and a batching module 1634. The connection manager 1622 preferably includes a radio controller 1636 and a heartbeat manager 1638. The request/transaction manager 1626 preferably includes an application behavior detector 1640, which comprises a pattern detector 1642, an application profile generator 1644, and a prioritization engine 1646.

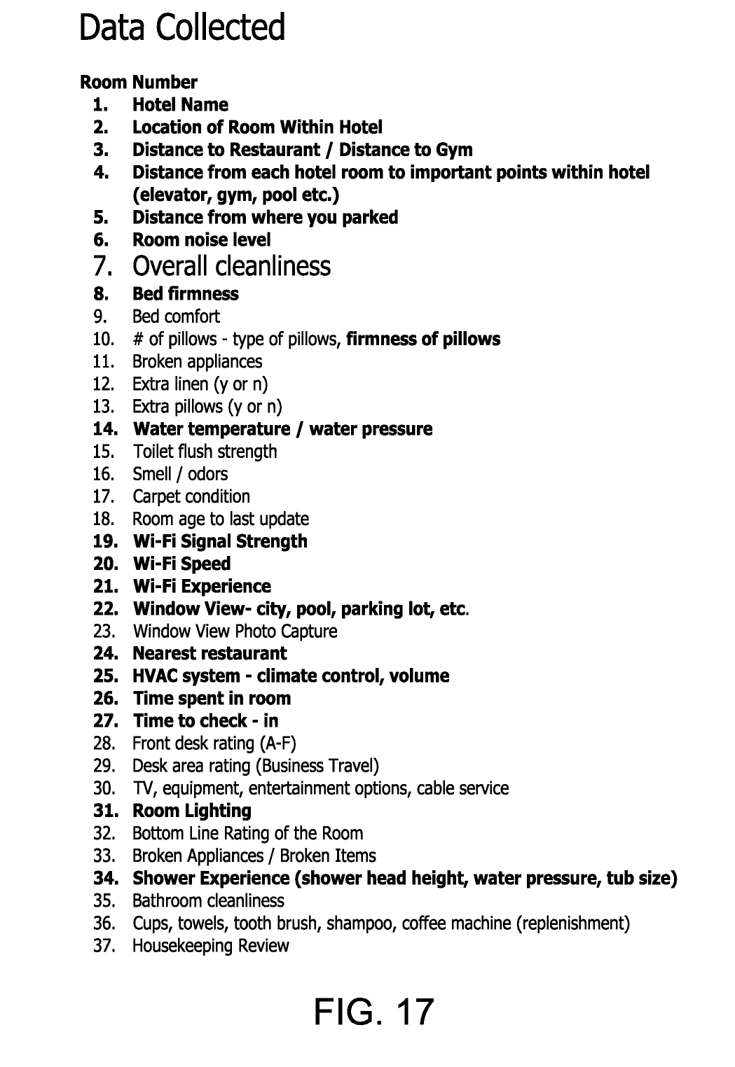

FIG. 17 illustrates the types of data that are collected by an application according to an exemplary embodiment of the invention. As shown, these include things such as the hotel name, the location of the room within the hotel, the distance to a restaurant or distance to a gym, the room noise level, the bed firmness, the Wi-Fi strength, the room lighting, or any other relevant factors that would influence a user's decision to select or enjoy a particular hotel room.

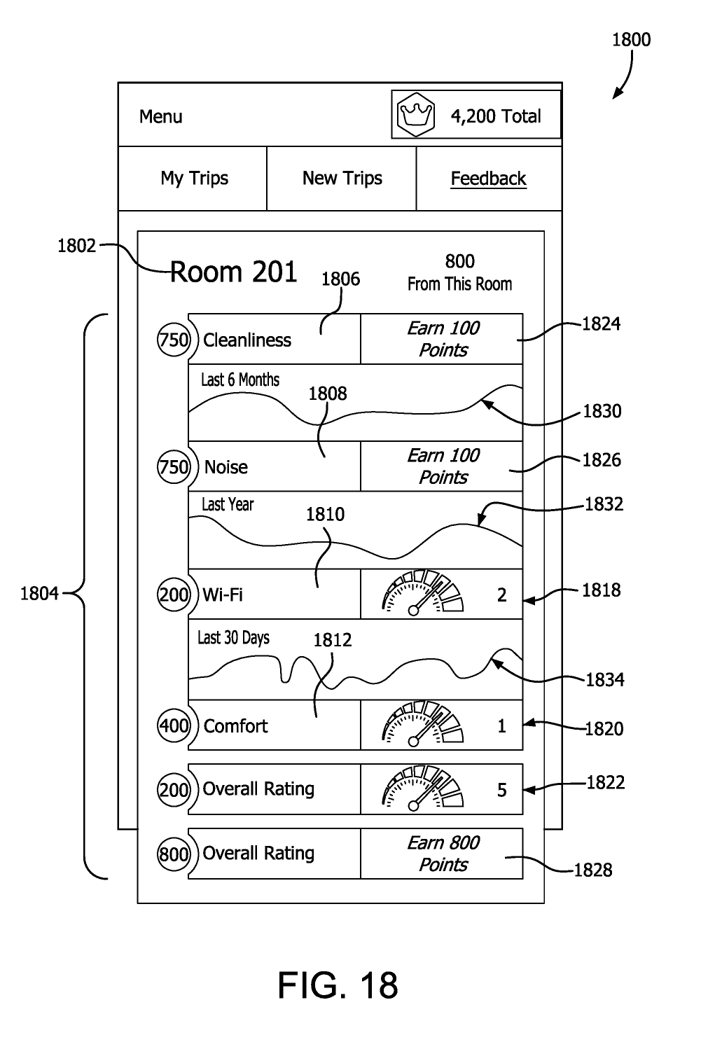

FIG. 18 illustrates a user interface 1800 that enables the user to provide feedback on a particular room within a hotel. As illustrated, the room number is displayed at 1802. Various rating factors are displayed at 1804. These can include, by way of example, cleanliness 1806, noise level 1808, Wi-Fi strength 1810, comfort 1812, broken items 1814, and an overall rating 1816. As shown, the app encourages users to be rewarded for providing their feedback in order to incentivize them to provide valuable and accurate feedback. As illustrated in FIG. 18, the feedback has already been provided for Wi-Fi, comfort, and broken items as illustrated at 1818, 1820, and 1822, respectively. Other factors have not yet been entered by the user and the user is prompted that they can earn points for providing feedback as to those factors. So for example, at 1824, the user is alerted that they can earn 100 points for providing feedback on cleanliness. At 1826, the user is informed that they can earn 100 points for providing feedback on the noise level of the room. At 1828, the user is advised they can earn 800 points for providing an overall rating. In addition, this user interface provides historical data regarding certain factors such as noise level 1830 over some historical periods such as the last six months. Similar historical graphs are displayed with respect to Wi-Fi at 1832, strength over the past year, and comfort level reported by guests in this room over the past 30 days at 1834.

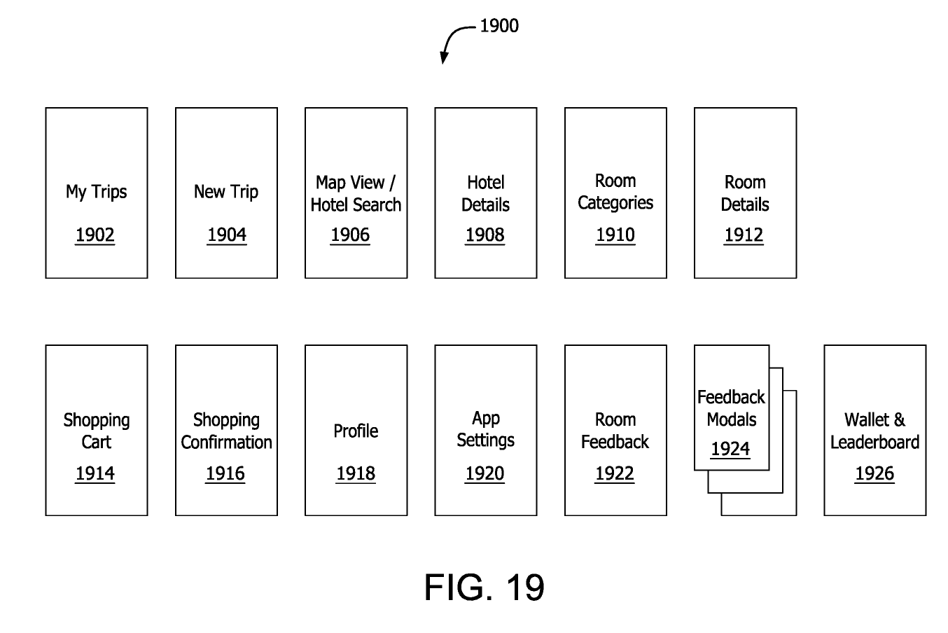

FIG. 19 illustrates a series of user interface screens that are provided in an app according to an exemplary embodiment of the invention. The series of user interface screens 1900 include a my trip screen 1902, a new trip screen 1904, a map view/hotel search screen 1906, hotel details screen 1908, room category screen 1910, room detail screen 1912, shopping cart screen 1914, shopping confirmation screen 1916, profile screen 1918, app settings screen 1920, room feedback screen 1922, a series of feedback modal screens 1924, and a wallet and leaderboard screen 1926. The series of user interface screens are, of course, exemplary and modifications additions, deletions, and various changes can be made to the series of screens as will be appreciated by one of ordinary skill in the art.

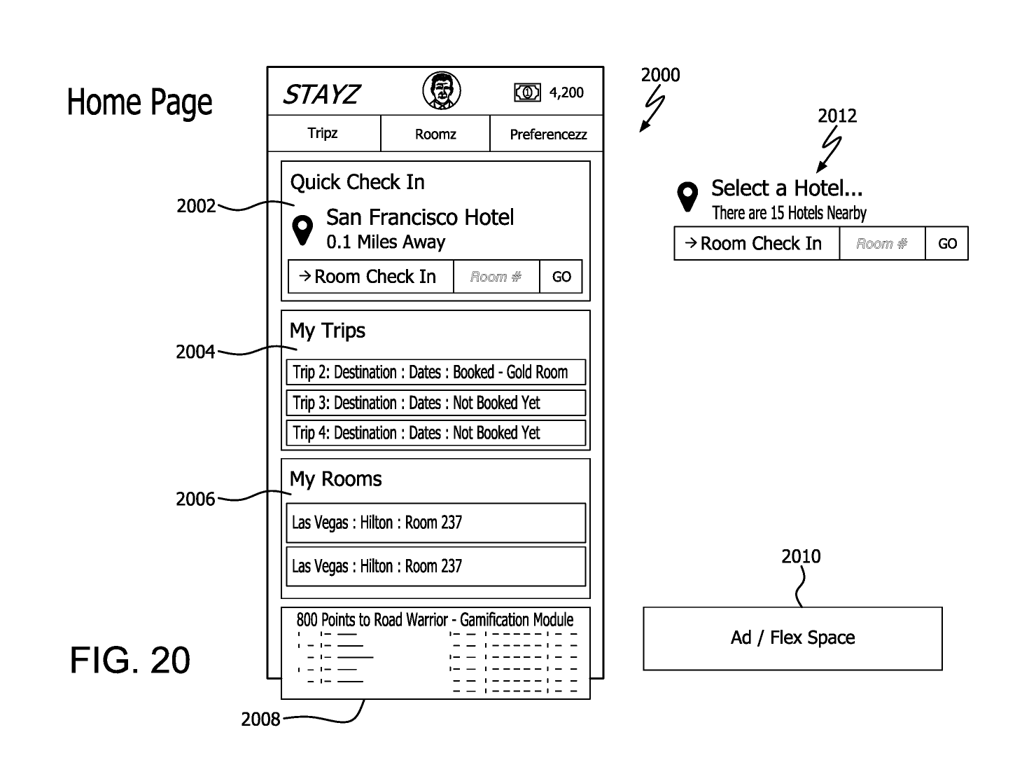

FIG. 20 illustrates a homepage 2000, a user-interface according to an exemplary embodiment of the invention. The homepage 2000 includes a quick check in area 2002, which permits a user to check into a room at a nearby hotel as determined by GPS or other location information provided by the mobile device. Homepage 2000 also includes a listing of the user's trips 2004 and a listing of the user's save your rooms 2006. Preferably, homepage 2000 also includes an incentive or gamification module 2008 that displays to the user how many points have accumulated, how they compare to other users and, for example, how many points they need to obtain a new level as a user. The homepage 2000 can also include ad space or flex space 2010 as an option and, as an alternative to the quick check in screen 2002, if there are many hotels nearby, the interface can change to permit the user to select one of the plurality of hotels are nearby as shown in 2012.

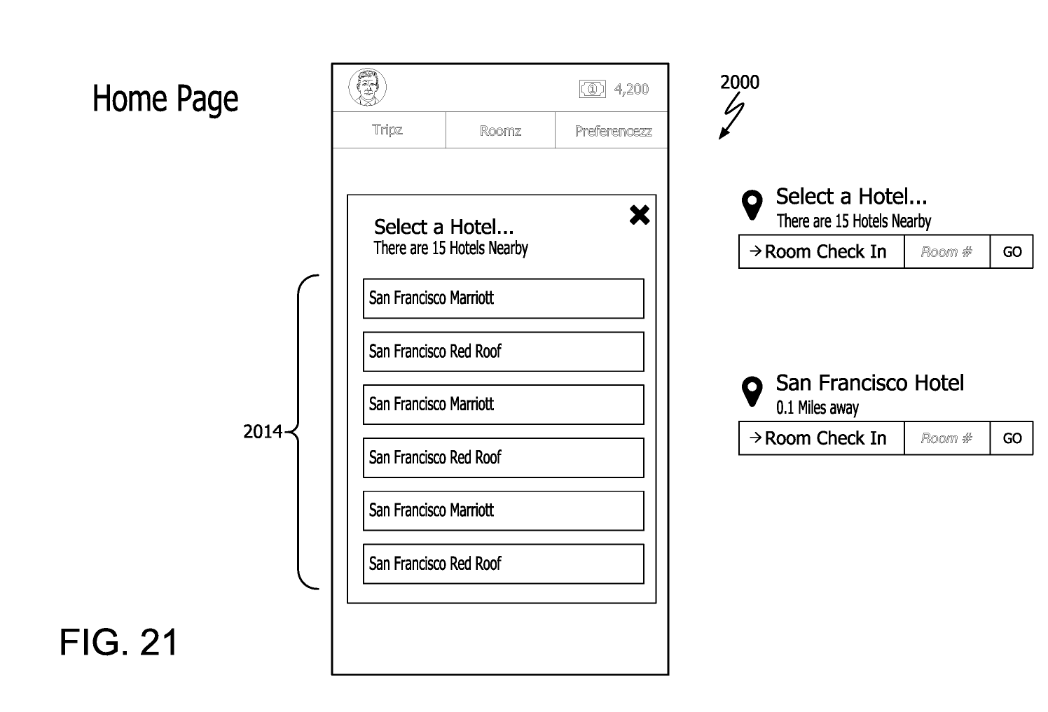

FIG. 21 illustrates the homepage 2000, modified when a user decides to select a hotel from the quick check-in screen 2012. As illustrated, a list of the nearby hotels 2014 are displayed to the user in a manner such that they can select one of the nearby hotels to choose a room and check in.

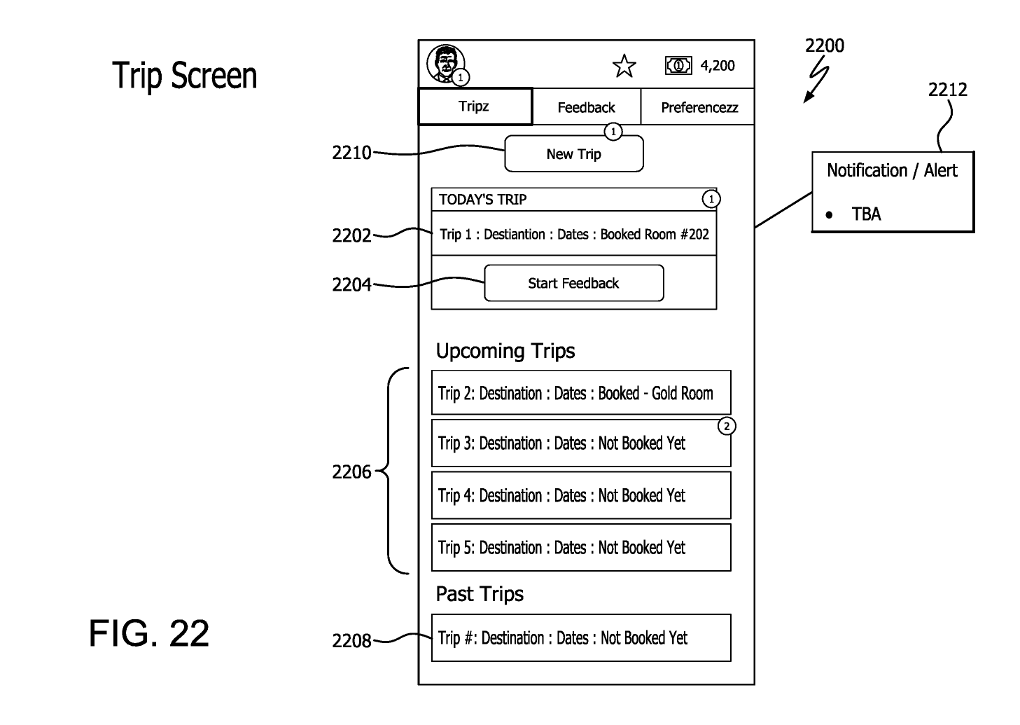

FIG. 22 illustrates a trip screen 2200 in accordance with an exemplary embodiment of the invention. The trip screen preferably includes an area to display any trips scheduled for the current date at 2202, and provides the user with an ability to begin providing feedback by selecting the control at 2204. Upcoming trips are listed at 2206, and past trips may optionally be listed at 2208. In addition, a new trip control button 2210 is provided to permit the user to begin planning a new trip. The today's trip section 2202 can be provided as a notification or alert to the user as illustrated at 2212.

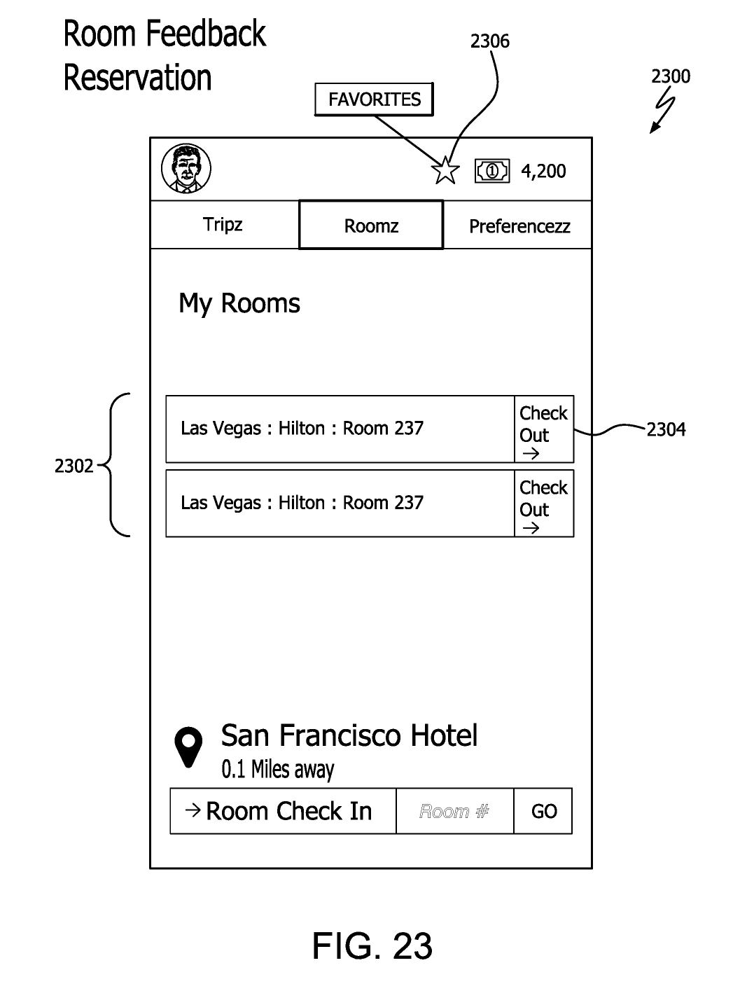

FIG. 23 illustrates an exemplary room feedback and reservation screen 2300 in accordance with an exemplary embodiment of the invention. Here, the user is shown the current or recent rooms where they have stayed at 2302, and they are provided a control by which to check out of their current room at 2304. A control 2306 is provided to permit the user to designate a particular room as one of their favorites.

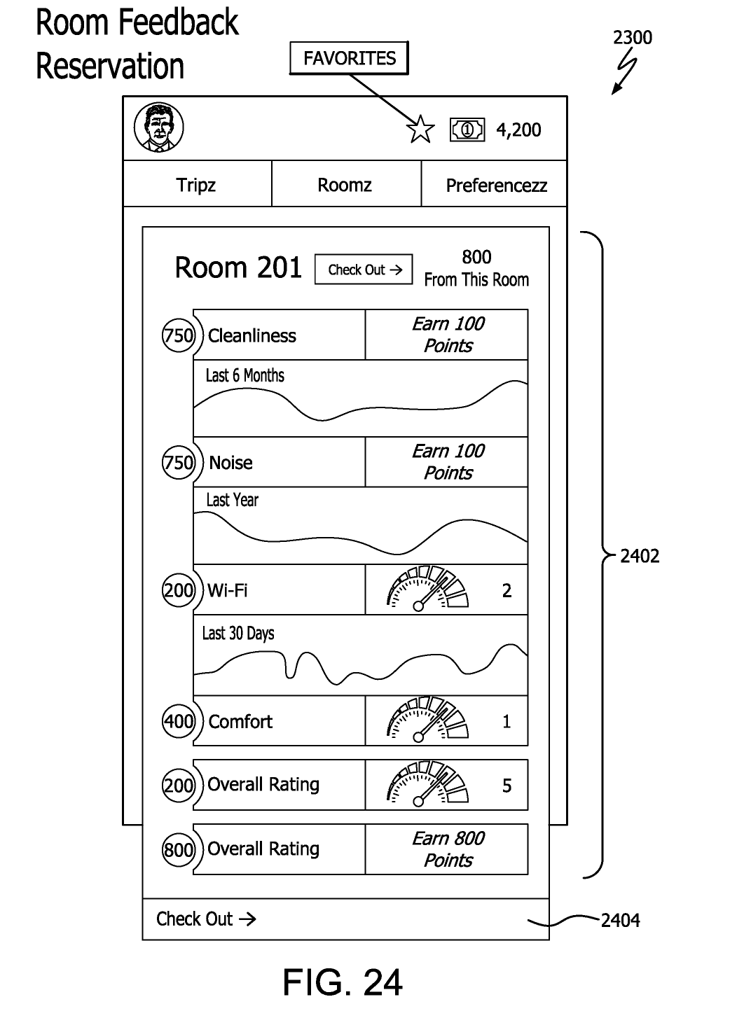

FIG. 24 illustrates the room feedback portion shown to a user when they are checking out. This feedback information 2402 is preferably solicited as part of the in app checkout process. The user provides feedback on the various factors as previously discussed, and then uses the checkout control 2404. In this manner, the user is again incentivized to provide feedback on a particular room within a particular hotel just prior to checkout.

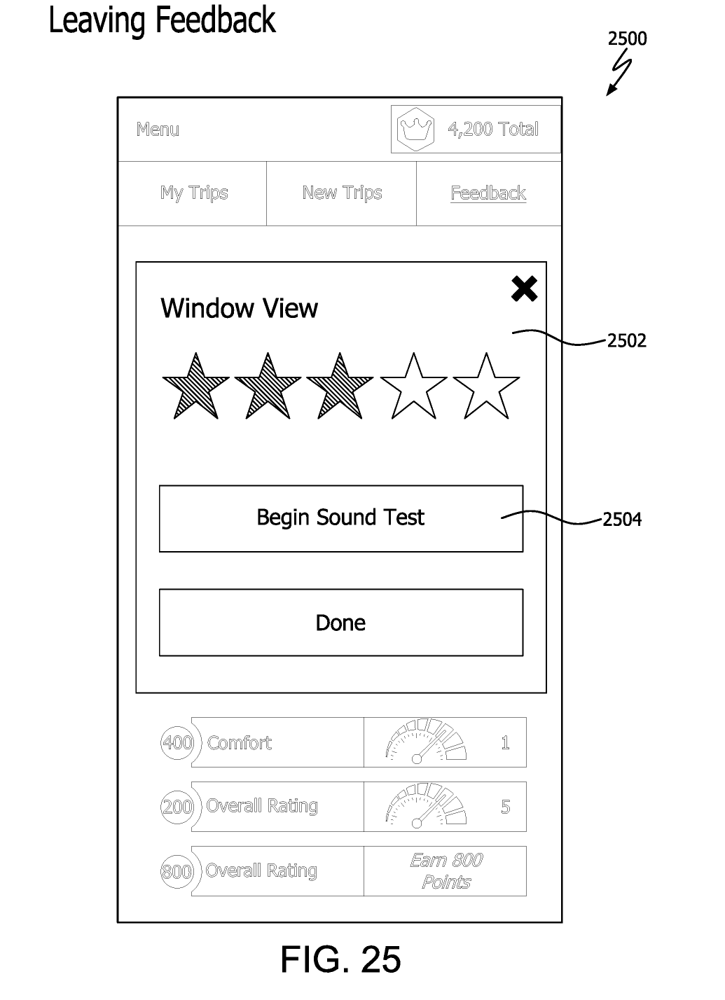

FIG. 25 illustrates an exemplary user interface screen 2500 for providing feedback according to an exemplary embodiment of the invention. Here, a feedback module for particular factor, in this case noise, is provided at 2502. The feedback can take the form of a qualitative or subjective analysis such as providing some number out of five stars show as shown. However, any suitable means of feedback is contemplated to be within the scope of the invention. In addition, more objective feedback can be provided by an app having sensors according to an exemplary embodiment invention. Here, at 2504, the user is provided with a control to begin a sound test. Beginning the sound test would, for example, turn on the microphone. The microphone could then record the ambient noise level to objectively measure beyond the noise level in a particular hotel room.

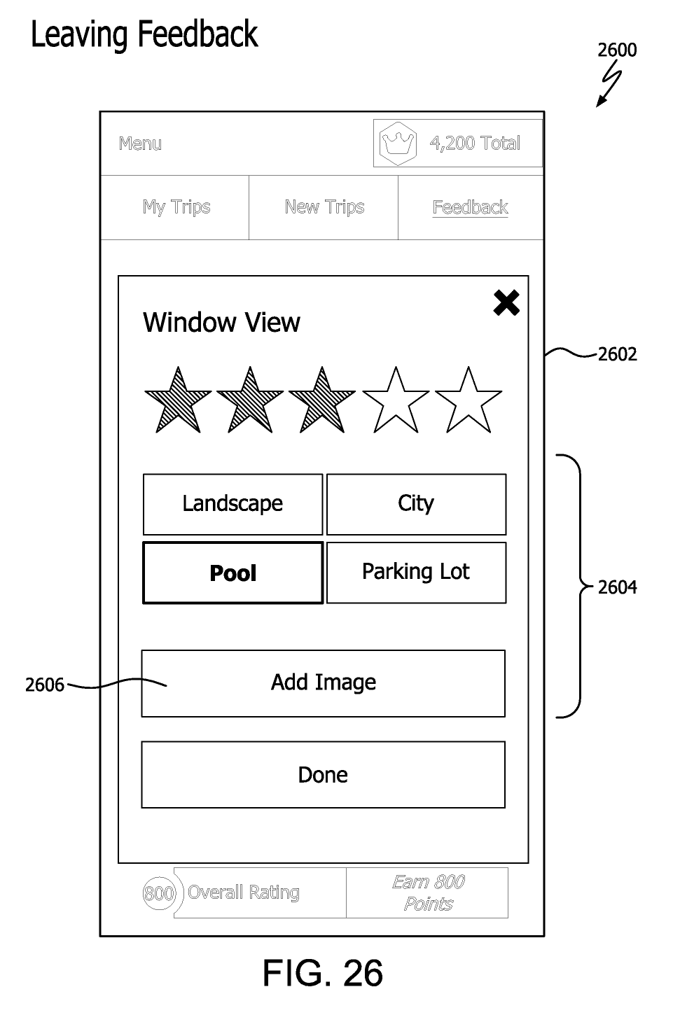

FIG. 26 provides a another user interface screen 2600 for providing feedback according to an exemplary embodiment of the invention. The subjective feedback control is provided at 2602 and the objective portion of the feedback for window view is provided 2604. Here, the user can select the type of view that is out their window. As an example, the user can select landscape, city, pool, or parking lot. For any of those particular views, the user can also click the add image control 2606 and use the camera in their mobile device to take an image of the actual window view.

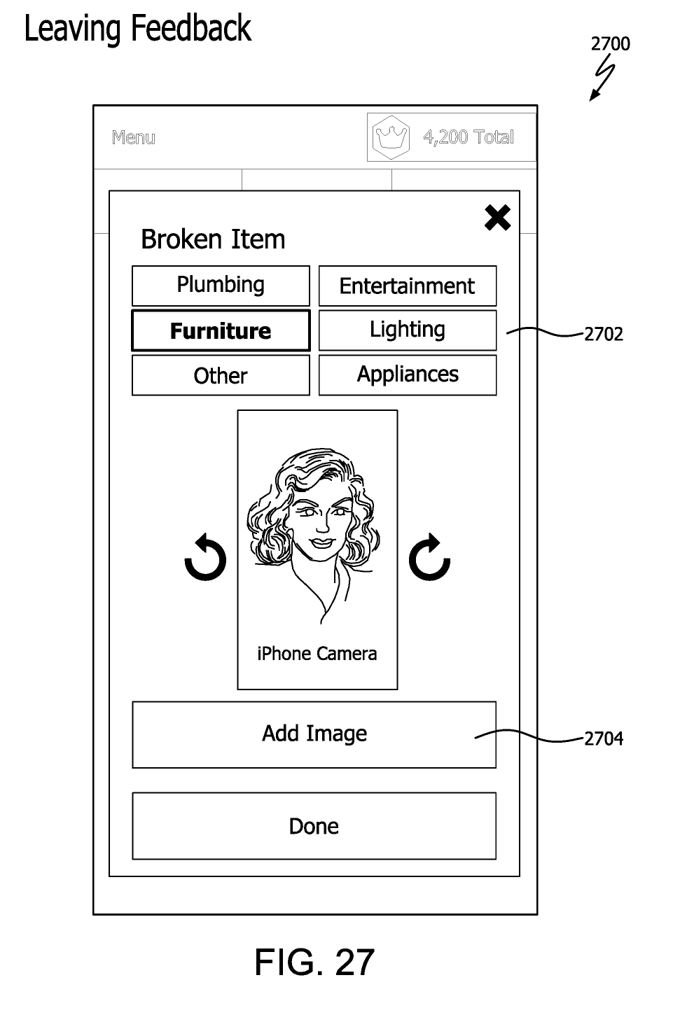

FIG. 27 provides another exemplary user interface screen for providing feedback according to an exemplary embodiment of the invention. User interface screen 27 is for providing information on a broken item within the room. As illustrated, the user can select a category for the broken item at 2702. Here, the exemplary categories include plumbing, furniture, entertainment, lighting, appliances, and other. As with the window view, the user can add an image using the add image control 2704 to further provide objective information on the broken item in the room.

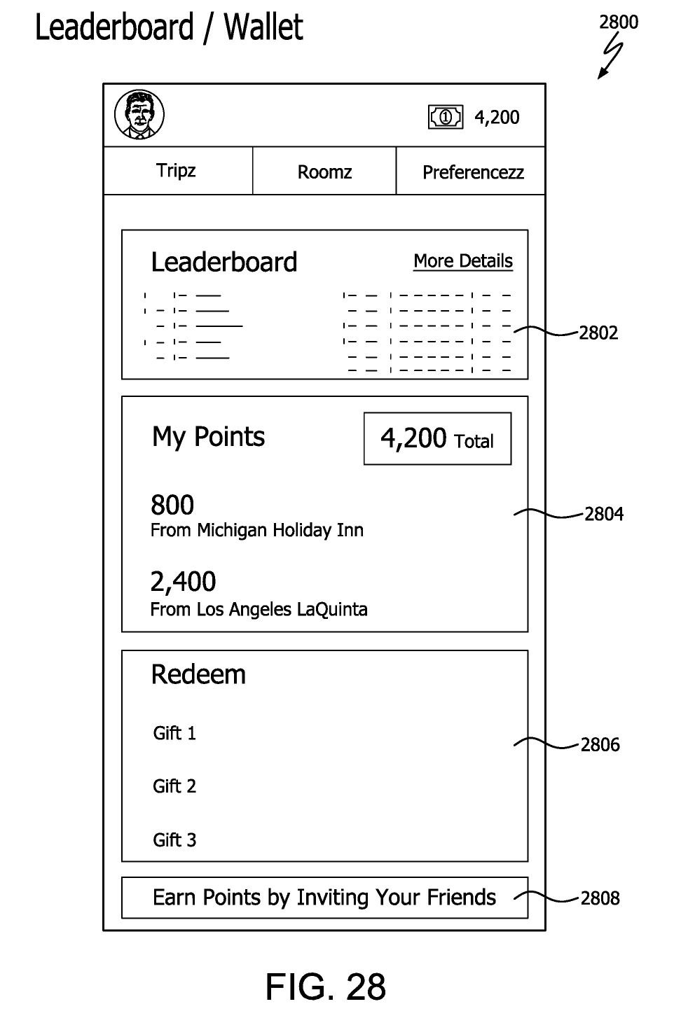

FIG. 28 illustrates a user interface screen for a user's leaderboard or while it according to an exemplary information. User interface screen 2800 preferably includes a leaderboard 2802, a description of user's points 2804, and a section for redeeming points for gifts or rewards at 2806. Finally, optionally, the user-interface screen 2800 provides a control for earning additional points by inviting friends to download the app or participate in the application at 2808.

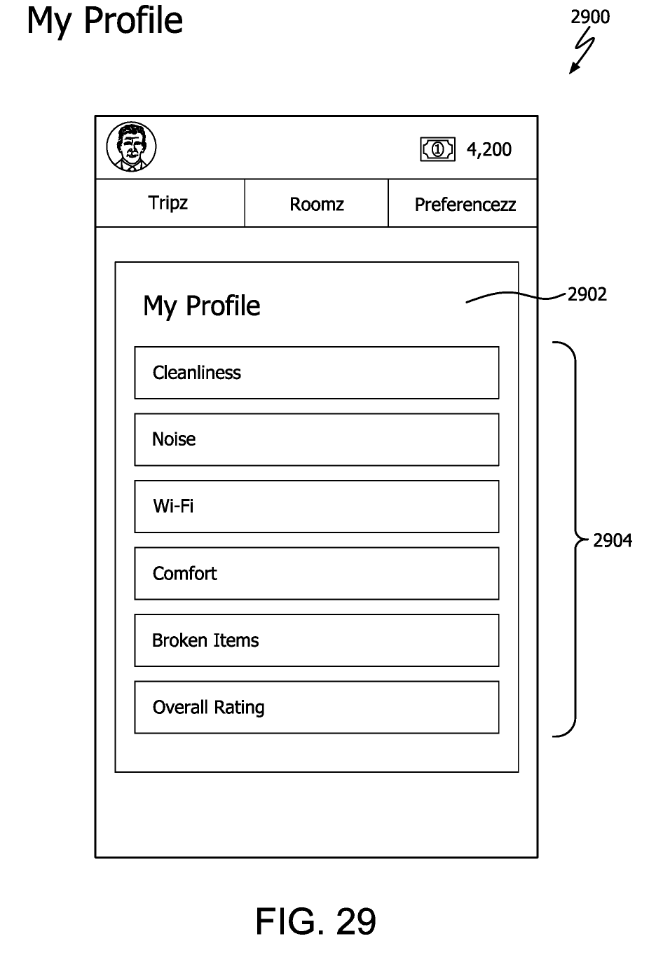

FIG. 29 is another user interface screen 2900 for displaying profile information according to an exemplary embodiment of the invention. A my profile section 2902 provides the user with a means to set their preferences for hotel room factors such as cleanliness, noise, Wi-Fi, comfort, broken items, and overall ratings at 2904.

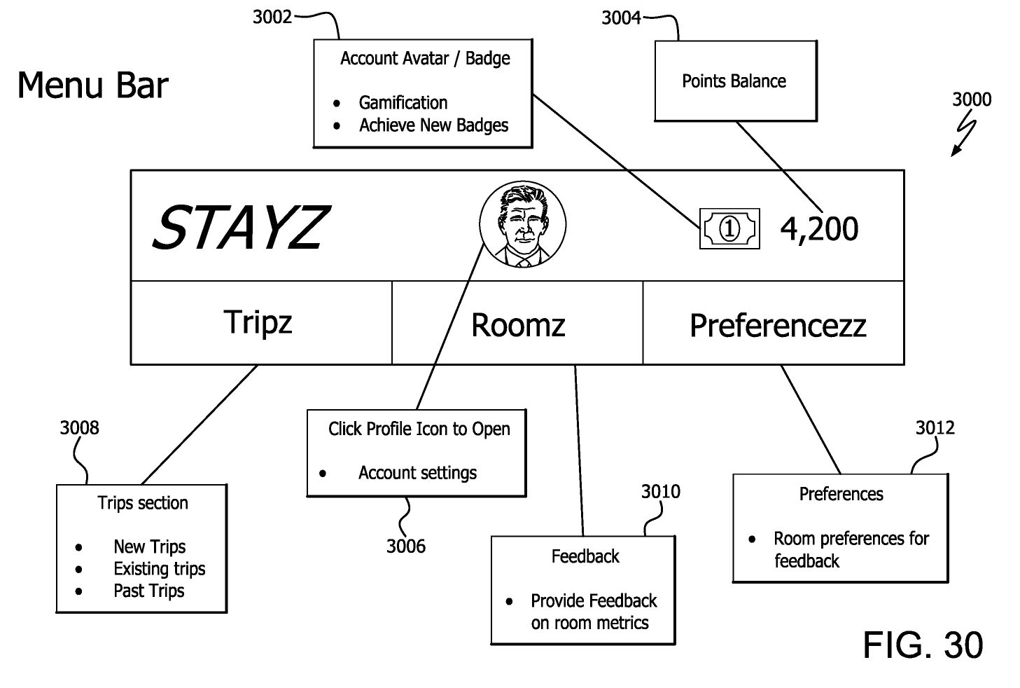

FIG. 30 is a close-up view of the menu bar provided on a user interface on a mobile device according to an exemplary embodiment of the invention. The menu bar 3000 includes an account avatar or badge 3002. User's experience with the app is preferably being gamified to encourage interaction with the app. For example, users may be awarded or achieve new badges which are displayed in the menu bar at 3002. A user's point balance is displayed at 3004. A user's profile icon is illustrated at 3006 and this icon also serves to open an account settings dialog. Three main tabs are provided that include a trips section 3008 where the user can set up new trips, review their existing trips or past trips. A rooms section 3010 permits the user to provide feedback on various room metrics as described above and a preferences section 3012 permits the user to indicate their preferences for hotel rooms.

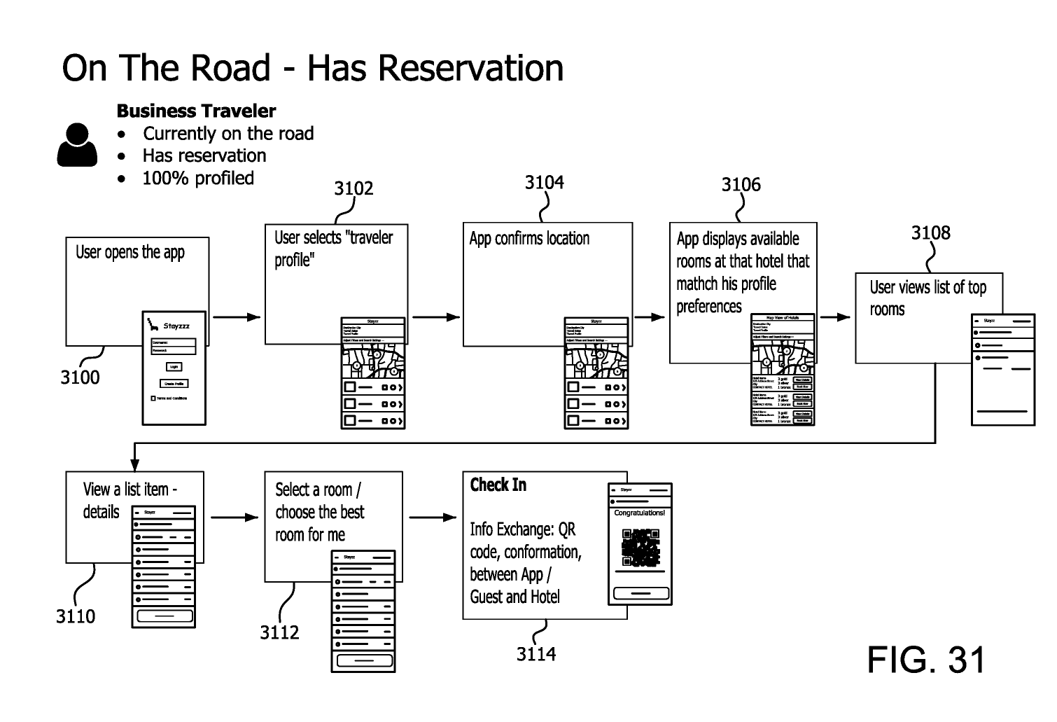

FIG. 31 illustrates an exemplary workflow for a business traveler finding and checking into a room using an embodiment of the present invention. At 3100, a business traveler on the road with an existing reservation opens the stays app and logs at 3100. They select their traveler profile at 3102, then the app confirms their location at 3104. The app next displays available rooms at their hotel that match the user's profile preferences at 3106. Next, the app displays a list of top rooms according to the best matches to the user's profile at 3108. The user can view a list of room details for each of the rooms to see how they match his or her preferences at 3110. The user selects a room at 3112. At 3114, they can check in and the app can provide, for example, a QR code or some other confirmation information that can confirm this user for the hotel when the user arrives at the hotel.

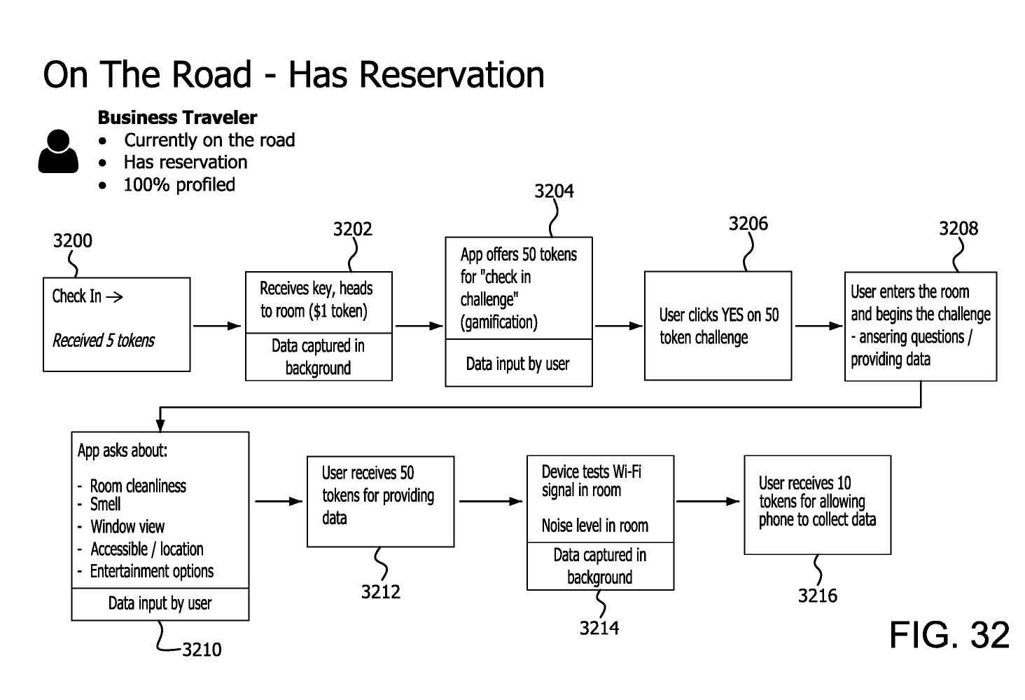

FIG. 32 further receives gamification activities that occur while a business traveler checks in. For example, when the user checks into a hotel at 3200, they receive five tokens. They arrive at the hotel, receive their key and head to their room at 3202, and in the background, the fact of their arrival and receiving a key and entering their room is captured by the app as a background process. At 3204, the user's is offered a check in challenge with a reward of 50 tokens. At 3206, the user clicks yes or no to accept or decline the check in challenge, and if they click yes, the game continues to step 3208, wherein the user enters the room and begins their challenge answering questions and providing data to the app. At step 3210, as part of the challenge, the app asks the user about the room cleanliness, the smell, the window view, accessibility and location within the hotel, the entertainment options, or any other suitable feedback regarding the room. At step 3212, the user is rewarded with 50 tokens for providing the feedback data. At step 3214, the user's mobile device tests the Wi-Fi signal and the noise level in the room. Accordingly, the phone utilizes its own sensors to measure objective criteria of the room. At step 3216, user receives an additional 10 tokens for allowing the phone to collect objective data.

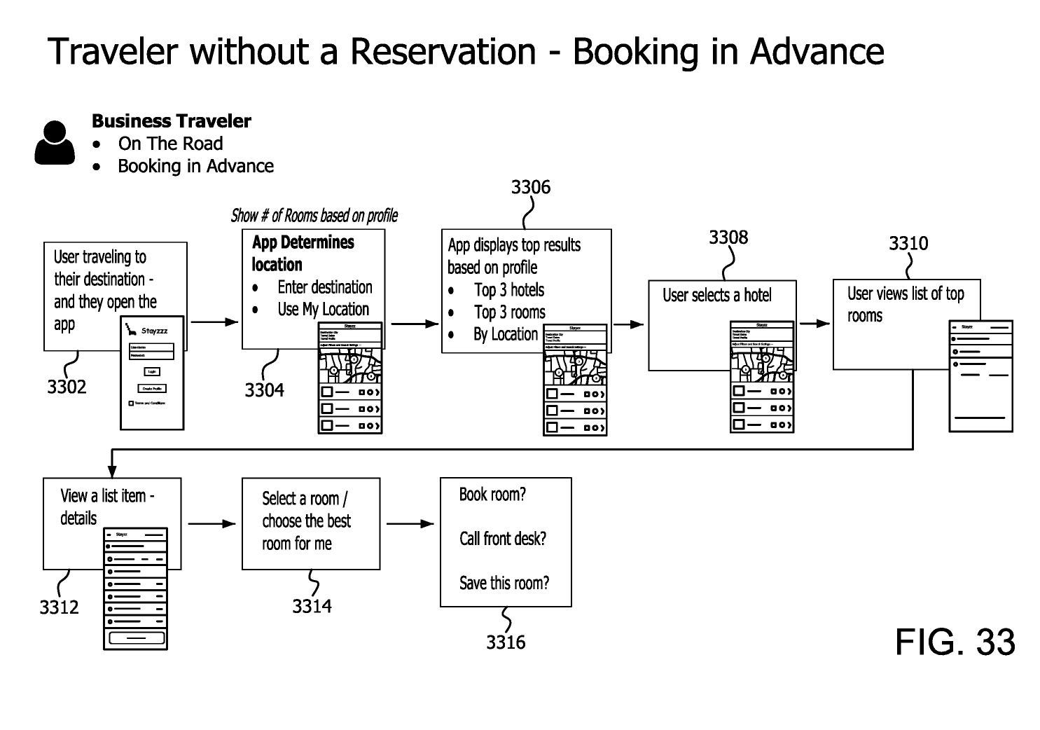

FIG. 33 illustrates a work flow of a business traveler without a reservation using the application according to an exemplary embodiment of the invention to book a room in advance. At step 3302, the user traveling on the way to their destination opens the app on their mobile device. At step 3304, the app determines the user's location. The user has the option to either use the current location or enter a destination location, and the app automatically retrieves a number of rooms that best match the user's profile and preferences. At step 3306, the app displays top results based on the user's profile. This can include the top three hotels, the top three rooms or the top rooms by location. At step 3308, a user selects a hotel. At step 3310, a list of the top matching rooms within the selected hotel are displayed for the user. At step 3312, the user can view details on particular rooms from the list. At step 3314, the user selects a room that best fits their preferences and at step 3316, the app moves on to a process of booking the room which can include automatically booking the room through the hotel database, calling the front desk, or simply saving the particular room to present at the hotel upon arrival.

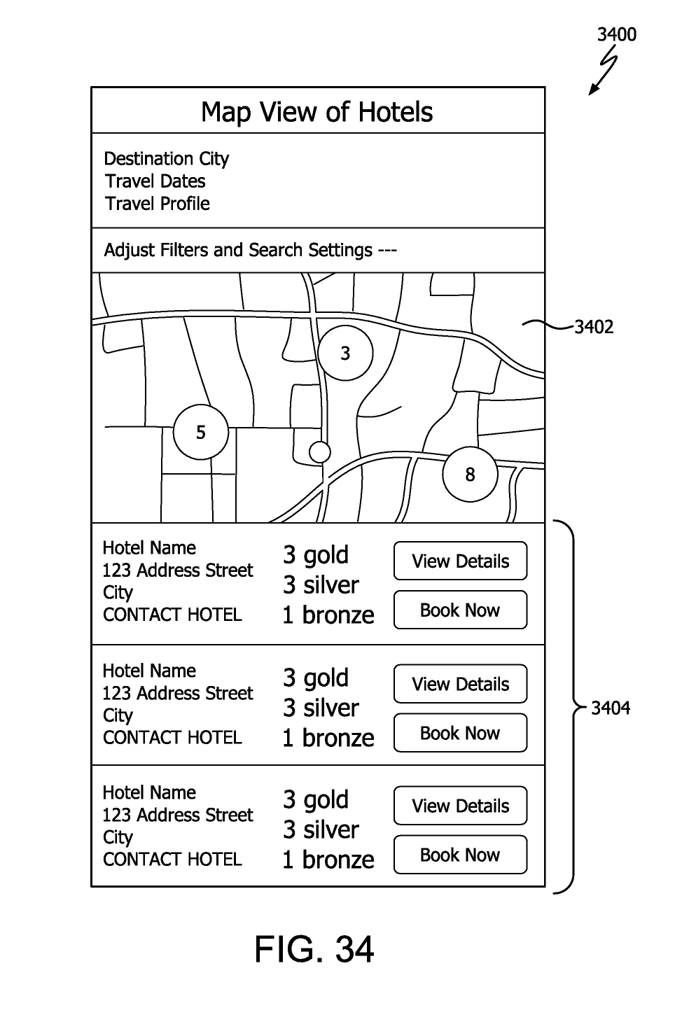

FIG. 34 illustrates an exemplary user interface 3400 of a map view of hotels near a particular area. As illustrated, the user interface includes a map portion 3402 along with a list of hotels 3404 shown in the map view.

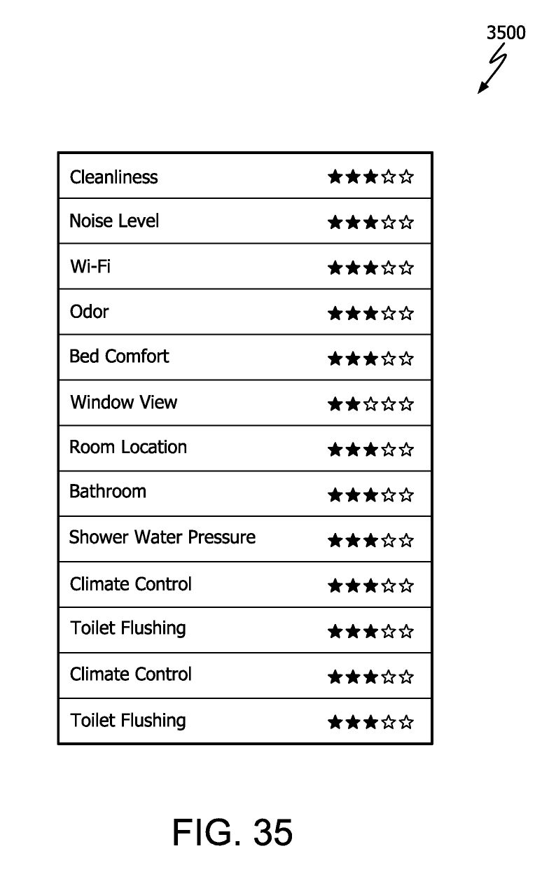

FIG. 35 illustrates an exemplary user interface 3500 for providing feedback regarding a number of properties of a particular hotel room.

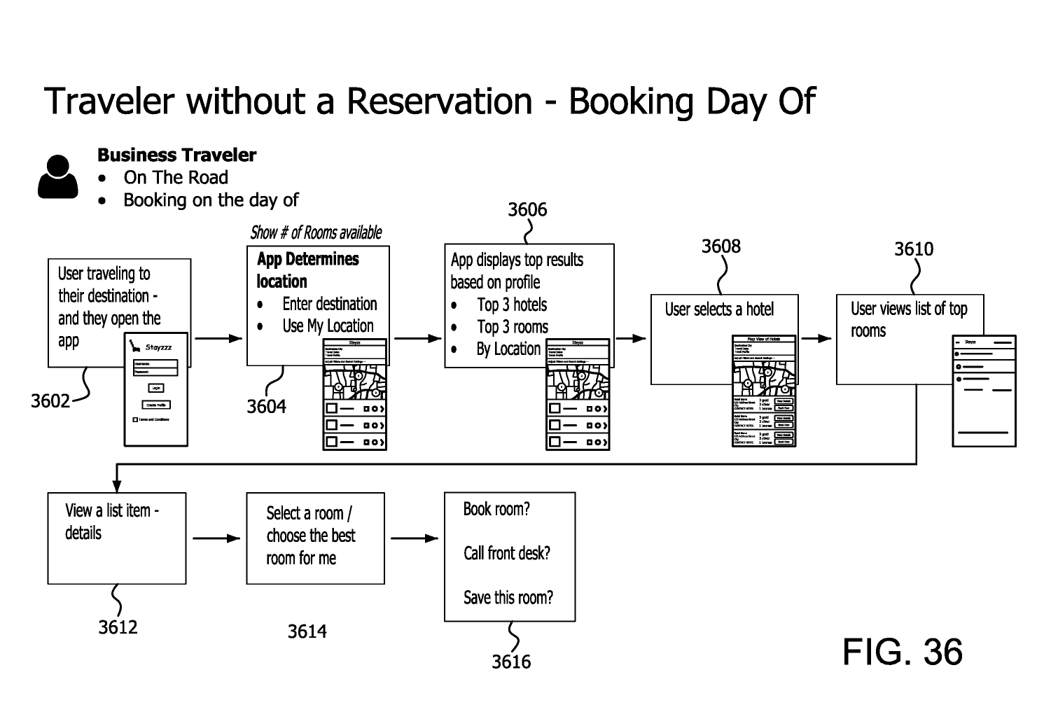

FIG. 36 illustrates a workflow of a business traveler without a reservation booking a hotel room on the day of their arrival according to an exemplary embodiment of the invention. At step 3602, a user on the way to their destination opens the app and logs in. At step 3604, the app determines a user's location or permits the user to enter a destination location and shows a number of rooms available in the area. At step 3606, the app displays a list of the top results based on the best matches to the user's profile. At step 3608, the user selects a particular hotel. At step 3610, the user views a list of the top rooms that match the user's preferences within the selected hotel. At step 3612, the app displays a list of details for a particular room as chosen by the user and at step 3614, the user selects a particular room that best fits the user's preferences. At step 3616, the app continues to a room booking procedure as discussed above.

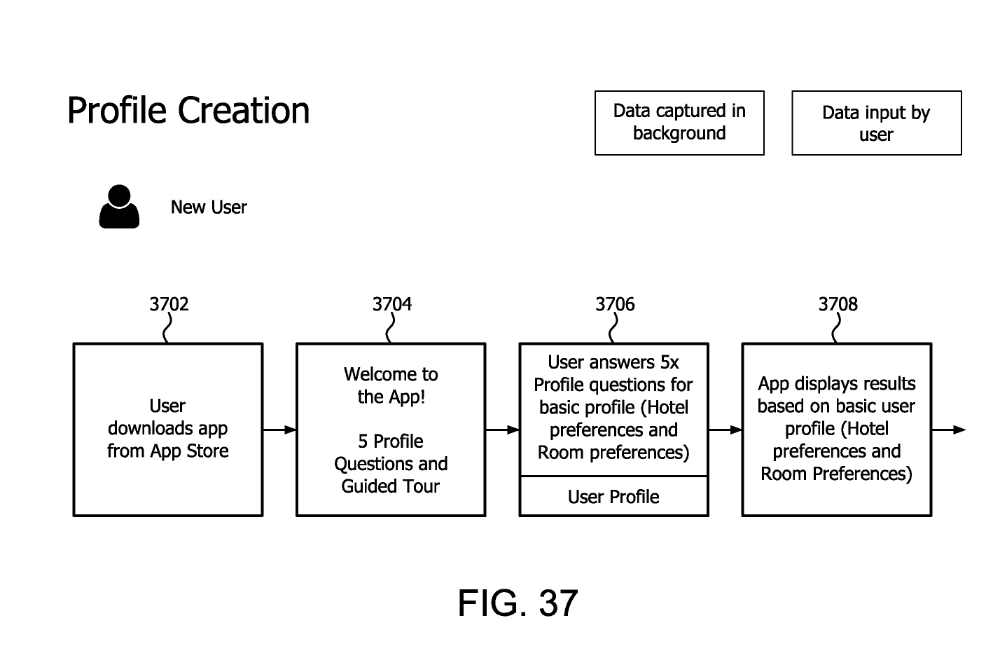

FIG. 37 illustrates an exemplary workflow for a new user using an upgrade on exemplary embodiment of the invention for the first time. At step 3702, the user downloads the app from the relevant app store. At step 3704, the app runs through a welcome procedure including asking a series of profile questions and giving a guided tour of the app. At step 3706, a user answers the basic profile questions and a user profile is established, At step 3708, the app displays results based on the basic user profile that has been created.

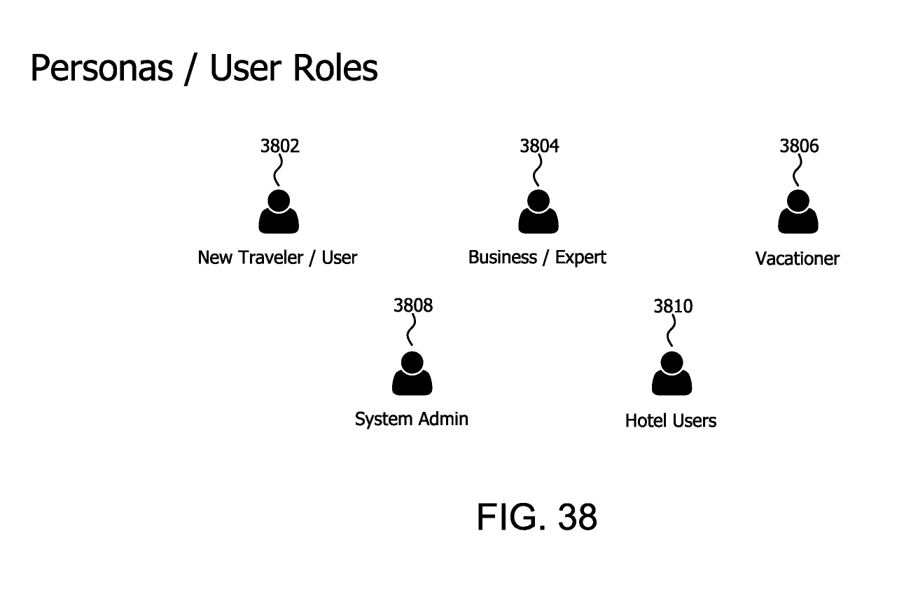

FIG. 38 illustrates different user roles associated with an exemplary app according to an embodiment of the invention. The user roles include a new traveler or new user 3802, a business or expert user at 3804, a vacationer at 3806, the system administrator at 3808, and a hotel user at 3810. Each of these profiles will utilize different aspects of an app according to exemplary embodiments of the invention. For example, more or fewer features may be enabled based on the user role. A business or expert user 3804, for example, may prefer to have more options for feedback and more preferences for features of hotel rooms, than vacationer would. The system administrator is able to access backend information, and a hotel user may, for example, be able to view an accumulation of data and feedback provided by many users.

The foregoing descriptions should be understood to be merely exemplary, and those of ordinary skill in the art will readily appreciate that additions and modifications may be made without departing from the scope and spirit of the invention.

What is claimed is:

1. A hotel room identification system, comprising:
a computing device having a user interface, and a transceiver for communicating with remote devices;
a database storing room information related to individual rooms within a hotel;
wherein the mobile communication device receives preference parameters from a user via the user interface, and communicates with the database to identify one or more hotel rooms and to display the one or more hotel rooms to the user together with hotel room parameter data related to each room.

2. The hotel room identification system of claim 1, wherein the parameter data related to each room is compared to the user's preference parameters, and the one or more rooms a ranked according to how the parameter data compares to the user's preference parameters.

3. The hotel room identification system of claim 1, wherein the mobile communication device receives a room selection command from a user, and based thereon, transmits a room reservation request related to an individual selected hotel room to a hotel server.

4. The hotel room identification system of claim 3, wherein the hotel server receives the room reservation request, and processes the room reservation request generate a reservation for the room, and transmits a reservation confirmation to the mobile communication device.

5. The hotel room identification system of claim 4, wherein the mobile communication device receives the reservation confirmation, and displays the same on the user interface.

6. The hotel room identification system of claim 5, wherein the reservation confirmation is displayed on the user interface as a QR code.

7. The hotel room identification system of claim 2, wherein the database stores user profile information including user preferences related to the hotel room parameter data.

8. The hotel room identification system of claim 7, wherein the hotel room parameter data comprises at least one of cleanliness, ambient noise, wifi signal strength, comfort, distance of room to elevator, distance of room to vending machine, bed firmness, water pressure, and room lighting level.

9. A hotel room feedback system, comprising:
a computing device having a user interface, a transceiver for communicating with remote devices, and one or more sensors that sense physical parameters;
a database in communication with the computing device, the database storing room information including hotel room parameter data related to individual rooms within a hotel;
wherein the mobile communication device activates one or more sensors to sense physical parameters of an individual hotel room and transmits the sensor measurements to the database; and
wherein the database updates the room information based on the sensor measurements received from the computing device.

10. The hotel room feedback system of claim 9, wherein the one or more sensors include a microphone to measure ambient noise.

11. The hotel room feedback system of claim 9, wherein the one or more sensors include a camera to take photographs of aspects of a hotel room environment.

12. The hotel room feedback system of claim 9, wherein the one or more sensors include a gyroscope to measure movement within a hotel room.

13. The hotel room feedback system of claim 12, wherein the gyroscope measures mattress firmness when the mobile communication device is dropped onto a mattress.

14. The hotel room feedback system of claim 9, wherein the one or more sensors include a GPS sensor to sense location of a room within a hotel.

15. A method of evaluating individual hotel rooms, the method comprising the steps of:
storing hotel room parameter data associated with individual hotel rooms in a hotel room database;
measuring a physical parameter related to an individual hotel room with a sensor of a mobile device;
sending the measured physical parameter data to the hotel room database; and
updating the hotel room parameter data based on the sent measured physical parameter data.

16. The method of claim 15, further comprising the steps of:
requesting user input from a user via a user interface of the mobile device;
receiving user input in response of the request;
sending the user input data to the hotel room database; and
updating the hotel room parameter data based on the send user input data.

17. The method of claim 15, wherein the step of measuring a physical parameter comprises activating a microphone of the mobile device and measuring ambient noise level.

18. The method of claim 15, wherein the step of measuring a physical parameter comprises activating a gyroscope of the mobile device and measuring acceleration data while the mobile device is dropped onto a bed mattress of the hotel room.

19. The method of claim 15, wherein the step of measuring a physical parameter comprises activating a camera of the mobile device and measuring light level.

20. The method of claim 15, wherein the step of measuring a physical parameter comprises activating a location sensor of the mobile device and determining a location of the mobile device.

21. A non-transitory computer-readable medium for evaluating individual hotel rooms, comprising instructions store thereon, that when executed on a processor, perform the steps of:
storing hotel room parameter data associated with individual hotel rooms in a hotel room database;
measuring a physical parameter related to an individual hotel room with a sensor of a mobile device;
sending the measured physical parameter data to the hotel room database; and
updating the hotel room parameter data based on the sent measured physical parameter data.

22. The non-transitory computer-readable medium of claim 21 wherein the instructions further perform the steps of:
requesting user input from a user via a user interface of the mobile device;
receiving user input in response of the request;
sending the user input data to the hotel room database; and
updating the hotel room parameter data based on the send user input data.

23. The non-transitory computer-readable medium of claim 21 wherein the instructions further perform the step of measuring a physical parameter by activating a microphone of the mobile device and measuring ambient noise level.

24. The non-transitory computer-readable medium of claim 21 wherein the instructions further perform the step of measuring a physical parameter by activating a gyroscope of the mobile device and measuring acceleration data while the mobile device is dropped onto a bed mattress of the hotel room.

25. The non-transitory computer-readable medium of claim 21 wherein the instructions further perform the step of measuring a physical parameter by activating a camera of the mobile device and measuring light level.

26. The non-transitory computer-readable medium of claim 21 wherein the instructions further perform the step of measuring a physical parameter by activating a location sensor of the mobile device and determining a location of the mobile device.
